(19) United States
(12) Patent Application Publication
(10) Pub. No.: US 2026/0270858 A1
(43) Pub. Date: Sep. 10, 2026

(54) PARAMETRIZED SATELLITE SELECTION FOR SATELLITE-BASED COMMUNICATION

(71) Applicant: QUALCOMM Incorporated, San Diego, CA (US)

(72) Inventors: Kannan MUTHURAMAN, Mission Viejo, CA (US); Udayan BHAWNANI, San Diego, CA (US); Francesco GRILLI, La Jolla, CA (US); Prashant Kumar SINGH, Gautam Budh Nagar (IN); Ricky TAI, Milpitas, CA (US); Venkat vinod PATCHA, San Diego, CA (US); Muhammad Arif MUNIF, San Diego, CA (US); Carl HARDIN, Encinitas, CA (US)

(21) Appl. No.: 19/151,123

(22) PCT Filed: Mar. 28, 2024
(86) PCT No.: PCT/US2024/021941

§ 371 Date: Jul. 25, 2025

(30) Foreign Application Priority Data
Mar. 30, 2023 (IN) 202321023773

(51) Int. Cl. H04W 48/20; H04B 7/185; H04W 24/10

(52) U.S. Cl. CPC H04W 48/20; H04B 7/1855; H04W 24/10

(57) ABSTRACT

A method for providing pointing information associated with a UE comprising: receiving assistance information from a network entity, wherein the assistance information comprises at least one condition each comprising: one or more validity criteria; and a communication satellite selection indication indicative of one or more selected communication satellites of a plurality of communication satellites, wherein the communication satellite selection indication for at least one of the at least one condition is indicative of one or more of the plurality of communication satellites corresponding to a decision zone; determining a location of the UE; and producing directional pointing information to at least one of prompt a user of the UE to direct, or cause the UE to steer, an antenna beam of the UE toward the one or more selected satellites of the plurality of communication satellites based on the communication satellite selection indication and the location of the UE.

### CROSS-REFERENCE TO RELATED APPLICATIONS

This application claims the benefit of Indian Patent Application No. 202321023773, filed Mar. 30, 2023, entitled “PARAMETRIZED SATELLITE SELECTION FOR SATELLITE-BASED COMMUNICATION,” and claims the right of priority under 37 C.F.R. 1.55 and 35 U.S.C. 365(a). This application is assigned to the assignee hereof, and the entire contents of which are hereby incorporated herein by reference in its entirety.

### BACKGROUND

A communication satellite is an artificial satellite that orbits the Earth, and relays and amplifies radio telecommunication signals via a transponder. The communication satellite creates a radio communication channel between a source transmitter and a receiver at different geographic locations on Earth. Starting in the 1960's, communication satellite systems (herein referred to simply as “satellite systems”) have evolved to become the backbone of modern global communication systems where they are presently utilized for television, telephone, radio, Internet, and military applications.

As these satellite systems evolved, some of these satellite system incorporated the use of satellite constellations that include a group of satellites working in concert to provide varying types communication services for government, military, and private business. Some of these satellite constellations (such as, for example, the IRIDIUM®, GLOBALSTAR®), and STARLINK® systems) were designed to provide satellite telephonic and low-speed data services for most geographic areas on Earth. In general, these satellite constellations are designed to communicate with satellite telephones (also known as satellite phones, satphones, satellite terminals, mobile equipment, terminals, or satellite communication devices), which are mobile telephones (herein referred to simply as “mobile phones”) that are configured to connect to other telephones or the telephonic networks via radio links through the satellites orbiting the Earth instead of utilizing terrestrial cell sites, as cellphone-type mobile phones do. Therefore, these “satphones” may operate in most geographic locations on the Earth's surface (including remote areas), as long as an open sky and the line-of-sight between the satphone and the satellite exists. Depending on the architecture of a particular satellite constellation, coverage may include the entire Earth or only specific regions. In general, satphones provide similar functionality to terrestrial mobile phones, where voice calling, text messaging, and low-bandwidth Internet access are available. The advantage of a satphone is that the satphone can be used in regions where local terrestrial communication infrastructures, such as landline and cellular networks, are not available.

At present, the types and sizes of available satphones varies widely. Early satphones were handsets that had a size and weight comparable to that of a late-1980s or early-1990s mobile phone, but usually with a larger retractable antenna. More recently, satphones have become more compact and are now more similar in size to regular mobile phones. With this reduction in size, large omnidirectional antennas in prior satphones have been replaced with smaller directional antennas.

Low Earth Orbit (LEO) satellite networks provide coverage over a wide area of the Earth with low latency because of their low orbit altitudes. Compared to traditional satellite networks where satellites are positioned at higher altitudes, LEO satellite networks use more satellites to provide global coverage, due to the smaller coverage provided by these types of satellites which are positioned at low altitudes. For some LEO satellite networks, the satellites are uniformly distributed around the Earth in multiple orbits with multiple satellites placed in each orbit. When a group of satellites is arranged in predefined orbits, the pattern of the orbits is referred to as a constellation. As an example, a polar constellation is a constellation where each orbit of satellites in the constellation crosses the Earth's poles. In general, LEO satellites are launched into separate orbital planes with all the LEO satellites in the same orbital plane travelling in the same direction. Due to Earth's rotation, satellites that may be observed to be moving in a northward direction would later pass over the same point in a southward direction. At most places in the constellation, adjacent satellites in adjacent orbits will be travelling in the same direction. However, there are regions where satellites travelling in adjacent orbits will be travelling in opposite directions. These regions are given the term “orbital seam” or simply “seam.” Inter-satellite communication links may be difficult in a seam due to the relative velocity of the satellites in adjacent orbits on opposite sides of the seam. These communication links are only active for a short period of time as the satellites pass each other travelling in opposite directions and there the link may only be active for a short period of time. Moreover, some of the satellites travelling in one direction may deactivate their beams aimed at an area of the Earth to avoid overlap with the beams of the other satellites travelling in the opposite direction that are also aiming their respective beams at the same area on the Earth. Furthermore, with polar orbits, at higher latitudes, where multiple satellites are visible with respect to a user location, some satellites may deactivate their beams to conserve power irrespective of the direction of travel of the satellites.

### SUMMARY

Techniques are discussed for a user equipment (UE) comprising: at least one memory; at least one transceiver; at least one positioning device; and at least one processor in signal communication with the at least one memory, the at least one transceiver, and the at least one positioning device, the at least one processor configured to: receive, using the at least one transceiver, assistance information comprising at least one condition each comprising: one or more validity criteria; and a communication satellite selection indication indicative of one or more selected communication satellites of a plurality of communication satellites, wherein the communication satellite selection indication for at least one of the at least one condition is indicative of one or more of the plurality of communication satellites corresponding to a decision zone; determine, from information from the at least one positioning device, a location of the UE; and produce directional pointing information to at least one of prompt a user of the UE to direct, or cause the at least one transceiver to steer, an antenna beam of the at least one transceiver toward the one or more selected satellites of the plurality of communication satellites based on the communication satellite selection indication and the location of the UE.

Also disclosed is a method for providing pointing information associated with a user equipment (UE), the method comprising: receiving, using at least one transceiver of the UE, assistance information from a network entity, wherein the assistance information comprises at least one condition each comprising: one or more validity criteria; and a communication satellite selection indication indicative of one or more selected communication satellites of a plurality of communication satellites, wherein the communication satellite selection indication for at least one of the at least one condition is indicative of one or more of the plurality of communication satellites corresponding to a decision zone; determining a location of the UE; and producing directional pointing information to at least one of prompt a user of the UE to direct, or cause the UE to steer, an antenna beam of the UE toward the one or more selected satellites of the plurality of communication satellites based on the communication satellite selection indication and the location of the UE.

Also disclosed is a non-transitory, processor-readable storage medium comprising processor-readable instructions to cause at least one processor of a user equipment (UE) to: receive assistance information from a network entity, wherein the assistance information comprises at least one condition each comprising: one or more validity criteria; and a communication satellite selection indication indicative of one or more selected communication satellites of a plurality of communication satellites, wherein the communication satellite selection indication for at least one of the at least one condition is indicative of one or more of the plurality of communication satellites corresponding to a decision zone; determine a location of the UE from positioning signals; and produce directional pointing information to at least one of prompt a user of the UE to direct, or cause the UE to steer, an antenna beam of the UE toward the one or more selected satellites of the plurality of communication satellites based on the communication satellite selection indication and the location of the UE.

Also disclosed is a UE comprising: at least one memory; at least one transceiver; at least one positioning device; and at least one processor in signal communication with the at least one memory, the at least one transceiver, and the at least one positioning device, the at least one processor configured to: receive, using the at least one transceiver, assistance information comprising at least one condition each comprising: one or more validity criteria; and a communication satellite selection indication indicative of one or more selected communication satellites of a plurality of communication satellites, wherein the communication satellite selection indication for at least one of the at least one condition is indicative of one or more of the plurality of communication satellites corresponding to a decision zone; determine, from information from the positioning device, a location of the UE; and at least one of transmit a first signal for, or listen for a second signal from, each of one or more selected satellites of the plurality of communication satellites based on the communication satellite selection indication and the location of the UE.

Also disclosed is a method for satellite communication, the method comprising: receiving, using at least one transceiver of a user equipment (UE), assistance information from a network entity, wherein the assistance information comprises at least one condition each comprising: one or more validity criteria of the condition; and a communication satellite selection indication indicative of one or more selected communication satellites of a plurality of communication satellites, wherein the communication satellite selection indication for at least one of the at least one condition is indicative of one or more of the plurality of communication satellites corresponding to a decision zone; determining a location of the UE; and at least one of transmitting a first signal for or listening for a second signal from each of one or more selected satellites of the plurality of communication satellites based on the communication satellite selection indication and the location of the UE.

Also disclosed is a UE comprising: means for receiving assistance information from a network entity, wherein the assistance information comprises at least one condition each comprising: one or more validity criteria of the condition; and a communication satellite selection indication indicative of one or more selected communication satellites of a plurality of communication satellites, wherein the communication satellite selection indication for at least one of the at least one condition is indicative of one or more of the plurality of communication satellites corresponding to a decision zone; means for determining a location of the UE from positioning signals; and means for at least one of transmitting a first signal for or listening for a second signal from each of one or more selected satellites of the plurality of communication satellites based on the communication satellite selection indication and the location of the UE.

Also disclosed is a non-transitory, processor-readable storage medium comprising processor-readable instructions to cause a processor of a user equipment (UE) to: receive assistance information from a network entity, wherein the assistance information comprises at least one condition each comprising: one or more validity criteria of the condition; and a communication satellite selection indication indicative of one or more selected communication satellites of a plurality of communication satellites, wherein the communication satellite selection indication for at least one of the at least one condition is indicative of one or more of the plurality of communication satellites corresponding to a decision zone; determine a location of the UE from positioning signals; and at least one of transmit a first signal for or listen for a second signal from each of one or more selected satellites of the plurality of communication satellites based on the communication satellite selection indication and the location of the UE.

Also disclosed is a network entity comprising: at least one memory; at least one transceiver; and at least one processor in signal communication with the at least one memory and the at least one transceiver, the at least one processor configured to: obtain assistance information based on orbital information of a plurality of communication satellites, the assistance information comprising at least one condition each comprising: one or more validity criteria; and a communication satellite selection indication indicative of one or more communication satellites of the plurality of communication satellites, wherein the communication satellite selection indication for at least one of the at least one condition is indicative of one or more of the plurality of communication satellites corresponding to a decision zone; and transmit the assistance information to a user equipment (UE) utilizing the at least one transceiver.

Also disclosed is a method for providing assistance information, the method comprising: obtaining, at a network entity, assistance information based on orbital information of a plurality of communication satellites, the assistance information comprising at least one condition each comprising: one or more validity criteria of the condition; and a communication satellite selection indication indicative of one or more communication satellites of the plurality of communication satellites, wherein the communication satellite selection indication for at least one of the at least one condition is indicative of one or more of the plurality of communication satellites corresponding to a decision zone; and transmitting, utilizing at least one transceiver, the assistance information from the network entity to a user equipment (UE).

Also disclosed is a network entity comprising: means for obtaining assistance information based on orbital information of a plurality of communication satellites, the assistance information comprising at least one condition each comprising: one or more validity criteria of the condition; and a communication satellite selection indication indicative of one or more communication satellites of the plurality of communication satellites, wherein the communication satellite selection indication for at least one of the at least one condition is indicative of one or more of the plurality of communication satellites corresponding to a decision zone; and means for transmitting the assistance information from the network entity to a user equipment (UE).

Also disclosed is a non-transitory, processor-readable storage medium comprising processor-readable instructions to cause a processor of a network entity to: obtain assistance information based on orbital information of a plurality of communication satellites, the assistance information comprising at least one condition each comprising: one or more validity criteria of the condition; and a communication satellite selection indication indicative of one or more communication satellites of the plurality of communication satellites, wherein the communication satellite selection indication for at least one of the at least one condition is indicative of one or more of the plurality of communication satellites corresponding to a decision zone; and transmit the assistance information from the network entity to a user equipment.

Other devices, apparatuses, systems, methods, features, and advantages of the invention will be or will become apparent to one with skill in the art upon examination of the following figures and detailed description. It is intended that all such additional devices, apparatuses, systems, methods, features, and advantages be included within this description, be within the scope of the invention, and be protected by the accompanying claims.

### BRIEF DESCRIPTION OF THE DRAWINGS

FIG. 1 is a simplified diagram of an example wireless communications system.

FIG. 2 is a system block diagram of components of an example user equipment shown in FIG. 1.

FIG. 3 is a system block diagram of components of an example transmission/reception point shown in FIG. 1.

FIG. 4 is a system block diagram of components of an example server shown in FIG. 1.

FIG. 5 is a simplified block diagram of an example user equipment (UE).

FIG. 6 is block flow diagram of a method for facilitating positioning determination of a UE.

FIG. 7 is a simplified system block diagram of an example of a communication system.

FIG. 8 is a system diagram showing a LEO (Low Earth Orbit) satellite constellation orbiting the Earth.

FIG. 9 is a side elevation view of an example of the LEO satellite constellation shown in FIG. 8.

FIG. 10 is a polar view of the LEO satellite constellation as shown in FIGS. 8 and 9.

FIG. 11 is a two-dimensional schematic view of the constellation shown in FIGS. 8 through 10.

FIG. 12 is a system diagram of an example of an implementation of a system for satellite-based communication.

FIG. 13A is a schematic diagram of a UE attempting to communicate with either of two LEO satellites of an orbital seam where the LEO satellites are traveling in opposite directions.

FIG. 13B is a schematic diagram of a UE attempting to communicate with either of two LEO satellites that are traveling in the same direction and that are not at an orbital seam.

FIG. 14 is a plot of signal-to-noise ratio (SNR) in decibels versus coordinated universal time (UTC) of LEO satellites of an orbital seam.

FIG. 15 is a plot of elevation in degrees versus UTC of orbital plane of LEO satellites of an orbital seam.

FIG. 16 is a plot of azimuth in degrees versus UTC of orbital plane of LEO satellites of an orbital seam.

FIG. 17 is a sky plot of usability of LEO satellites from orbital plane 6 of a six-plane constellation.

FIG. 18 is a sky plot of usability of LEO satellites from orbital plane 1 of a six-plane constellation.

FIG. 19 is a table of conditions for determining an availability of LEO communication satellites.

FIG. 20 is a block flow diagram of a method for attempting communication with one or more satellite vehicles.

FIG. 21 is a block flow diagram of a method for providing pointing information associated with a user equipment.

FIG. 22 is a block flow diagram of a method for providing assistance information.

FIG. 23 is a block flow diagram of a method for satellite communication.

FIG. 24 is a system block diagram of an example of an implementation of a system for satellite-based communication utilizing crowdsourcing.

### DETAILED DESCRIPTION

Techniques are discussed herein for satellite selection for satellite-based communications with a constellation of satellites. Values of parameters for satellite selection (e.g., prioritized satellite selection) may be provided to, and evaluated by, a user equipment (UE). In particular, conditions to select a preferred satellite may be provided, which may result in selection of, and attempted communication with, a satellite vehicle (SV) that is further away from the UE than another SV, where the closer SV is unavailable (e.g., a beam covering a location of the UE is turned off). Other configurations may be used.

As an example, a UE is discussed comprising: at least one memory; at least one transceiver; at least one positioning device; and at least one processor in signal communication with the at least one memory, the at least one transceiver, and the at least one positioning device, the at least one processor configured to: receive, using the at least one transceiver, assistance information comprising at least one condition each comprising: one or more validity criteria; and a communication satellite selection indication indicative of one or more selected communication satellites of a plurality of communication satellites, wherein the communication satellite selection indication for at least one of the at least one condition is indicative of one or more of the plurality of communication satellites corresponding to a decision zone; determine, from information from the at least one positioning device, a location of the UE; and produce directional pointing information to at least one of prompt a user of the UE to direct, or cause the at least one transceiver to steer, an antenna beam of the at least one transceiver toward the one or more selected satellites of the plurality of communication satellites based on the communication satellite selection indication and the location of the UE.

In one embodiment, the assistance information comprises parameters that are pre-determined for satellite selection based on crowdsourced information from either multiple UEs, or the same UE, and performing measurements at different times.

The description herein may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various examples described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, a UE may be any wireless communication device (e.g., a mobile phone, router, tablet computer, laptop computer, consumer asset tracking device, Internet of Things (IOT) device, etc.) used to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi& networks (e.g., based on IEEE (Institute of Electrical and Electronics Engineers) 802.11, etc.) and so on. Two or more UEs may communicate directly in addition to or instead of passing information to each other through a network.

A base station may operate according to one of several RATs in communication with UEs depending on the network in which it is deployed. Examples of a base station include an Access Point (AP), a Network Node, a NodeB, an evolved NodeB (eNB), or a general Node B (gNodeB, gNB). In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrowband Internet-of-Things (NB-IoT), enhanced mobile broadband (eMBB), or others) that may provide access for different types of devices. In some examples, the term “cell” may refer to a portion of a geographic coverage area (for example, a sector) over which the logical entity operates.

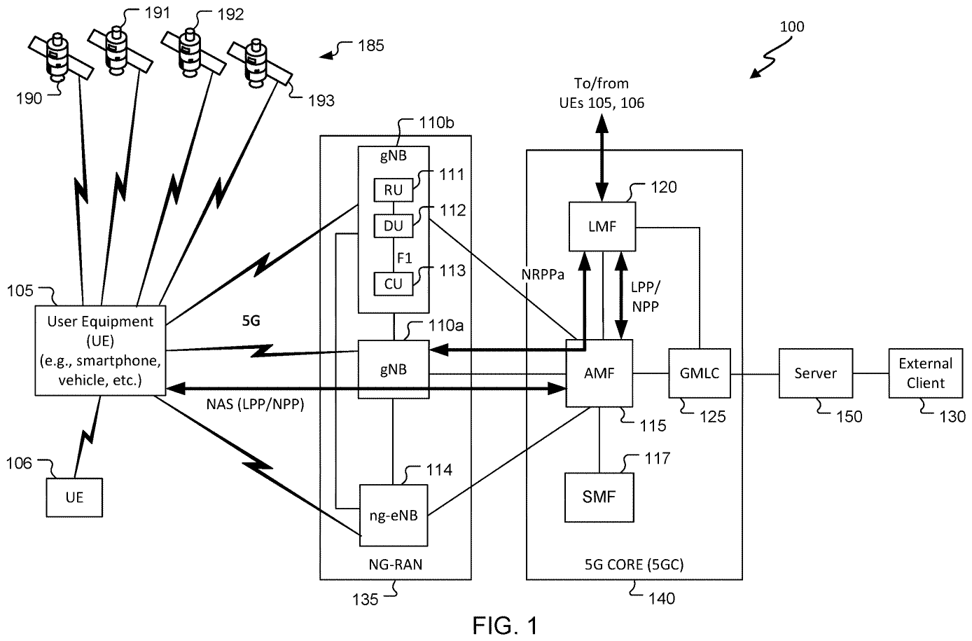

Referring to FIG. 1, an example of a communication system 100 includes a UE 105, a UE 106, a Radio Access Network (RAN), here a Fifth Generation (5G) Next Generation (NG) RAN (NG-RAN) 135, a 5G Core Network (5GC) 140, and a server 150. The UE 105 and/or the UE 106 may be, e.g., an IoT device, a location tracker device, a cellular telephone, a vehicle (e.g., a car, a truck, a bus, a boat, etc.), or another device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3rd Generation Partnership Project (3GPP). Accordingly, the NG-RAN 135 and the 5GC 140 may conform to current or future standards for 5G support from 3GPP. The NG-RAN 135 may be another type of RAN, e.g., a 3G RAN, a 4G Long Term Evolution (LTE) RAN, etc. The UE 106 may be configured and coupled similarly to the UE 105 to send and/or receive signals to/from similar other entities in the system 100, but such signaling is not indicated in FIG. 1 for the sake of simplicity of the figure. Similarly, the discussion focuses on the UE 105 for the sake of simplicity. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to (i.e., in signal communication with) each other, are each configured to bi-directionally wirelessly communicate with the UE 105, and are each communicatively coupled to, and configured to bi-directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions. Base stations such as the gNBs 110a, 110b and/or the ng-eNB 114 may be a macro cell (e.g., a high-power cellular base station), or a small cell (e.g., a low-power cellular base station), or an access point (e.g., a short-range base station configured to communicate with short-range technology such as WiFi®, WiFi®-Direct (WiFi®-D), Bluetooth®, Bluetooth®-low energy (BLE), Zigbee®, etc. One or more base stations, e.g., one or more of the gNBs 110a, 110b and/or the ng-eNB 114 may be configured to communicate with the UE 105 via multiple carriers. Each of the gNBs 110a, 110b and/or the ng-eNB 114 may provide communication coverage for a respective geographic region, e.g., a cell. Each cell may be partitioned into multiple sectors as a function of the base station antennas.

FIG. 1 provides a generalized illustration of various components, any or all of which may be utilized as appropriate, and each of which may be duplicated or omitted as necessary. Specifically, although one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may be replaced by or include various other location server functionality and/or base station functionality respectively.

The system 100 is capable of wireless communication in that components of the system 100 can communicate with one another (at least some times using wireless connections) directly or indirectly, e.g., via the gNBs 110a, 110b, the ng-eNB 114, and/or the 5GC 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples as the UE 105 is not required to be any of these configurations, and other configurations of UEs may be used. Other UEs may include wearable devices (e.g., smart watches, smart jewelry, smart glasses or headsets, etc.). Still other UEs may be used, whether currently existing or developed in the future. Further, other wireless devices (whether mobile or not) may be implemented within the system 100 and may communicate with each other and/or with the UE 105, the gNBs 110a, 110b, the ng-eNB 114, the 5GC 140, and/or the external client 130. For example, such other devices may include internet of thing (IoT) devices, medical devices, home entertainment and/or automation devices, etc. The 5GC 140 may communicate with the external client 130 (e.g., a computer system), e.g., to allow the external client 130 to request and/or receive location information regarding the UE 105 (e.g., via the GMLC 125).

The UE 105 or other devices may be configured to communicate in various networks and/or for various purposes and/or using various technologies (e.g., 5G, Wi-Fi® communication, multiple frequencies of Wi-Fi® communication, satellite positioning, one or more types of communications (e.g., GSM (Global System for Mobiles), CDMA (Code Division Multiple Access), LTE (Long Term Evolution), V2X (Vehicle-to-Everything, e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi® (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105, 106 may communicate with each other through UE-to-UE sidelink (SL) communications by transmitting over one or more sidelink channels such as a physical sidelink synchronization channel (PSSCH), a physical sidelink broadcast channel (PSBCH), or a physical sidelink control channel (PSCCH). Direct wireless-device-to-wireless-device communications without going through a network may be referred to generally as sidelink communications without limiting the communications to a particular protocol.

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, consumer asset tracking device, navigation device, Internet of Things (IoT) device, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi® (also referred to as Wi-Fi®), Bluetooth® (BT), Worldwide Interoperability for Microwave Access (WiMax®), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi® Direct (WiFi(®)-D), Bluetooth®, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP. One or more of a group of UEs utilizing D2D communications may be within a geographic coverage area of a TRP. Other UEs in such a group may be outside such geographic coverage areas, or be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g., the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The gNBs 110a, 110b and/or the ng-eNB 114 may each comprise one or more TRPs. For example, each sector within a cell of a BS may comprise a TRP, although multiple TRPs may share one or more components (e.g., share a processor but have separate antennas). The system 100 may include macro TRPs exclusively or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

Each of the gNBs 110a, 110b and/or the ng-eNB 114 may include a radio unit (RU), a distributed unit (DU), and a central unit (CU). For example, the gNB 110b includes an RU 111, a DU 112, and a CU 113. The RU 111, DU 112, and CU 113 divide functionality of the gNB 110b. While the gNB 110b is shown with a single RU, a single DU, and a single CU, a gNB may include one or more RUs, one or more DUs, and/or one or more CUs. An interface between the CU 113 and the DU 112 is referred to as an F1 interface. The RU 111 is configured to perform digital front end (DFE) functions (e.g., analog-to-digital conversion, filtering, power amplification, transmission/reception) and digital beamforming, and includes a portion of the physical (PHY) layer. The RU 111 may perform the DFE using massive multiple input/multiple output (MIMO) and may be integrated with one or more antennas of the gNB 110b. The DU 112 hosts the Radio Link Control (RLC), Medium Access Control (MAC), and physical layers of the gNB 110b. One DU can support one or more cells, and each cell is supported by a single DU. The operation of the DU 112 is controlled by the CU 113. The CU 113 is configured to perform functions for transferring user data, mobility control, radio access network sharing, positioning, session management, etc. although some functions are allocated exclusively to the DU 112. The CU 113 hosts the Radio Resource Control (RRC), Service Data Adaptation Protocol (SDAP), and Packet Data Convergence Protocol (PDCP) protocols of the gNB 110b. The UE 105 may communicate with the CU 113 via RRC, SDAP, and PDCP layers, with the DU 112 via the RLC, MAC, and PHY layers, and with the RU 111 via the PHY layer.

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications, or directly with the gNBs 110a, 110b and/or the ng-eNB 114. The LMF 120 may support positioning of the UE 105 when the UE 105 accesses the NG-RAN 135 and may support position procedures/methods such as Assisted GNSS (A-GNSS), Observed Time Difference of Arrival (OTDOA) (e.g., Downlink (DL) OTDOA or Uplink (UL) OTDOA), Round Trip Time (RTT), Multi-Cell RTT, Real Time Kinematic (RTK), Precise Point Positioning (PPP), Differential GNSS (DGNSS), Enhanced Cell ID (E-CID), angle of arrival (AoA), angle of departure (AoD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value added LMF (VLMF). A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g., by the LMF 120). The AMF 115 may serve as a control node that processes signaling between the UE 105 and the 5GC 140, and may provide QoS (Quality of Service) flow and session management. The AMF 115 may support mobility of the UE 105 including cell change and handover and may participate in supporting signaling connection to the UE 105.

The server 150, e.g., a cloud server, is configured to obtain and provide location estimates of the UE 105 to the external client 130. The server 150 may, for example, be configured to run a microservice/service that obtains the location estimate of the UE 105. The server 150 may, for example, pull the location estimate from (e.g., by sending a location request to) the UE 105, one or more of the gNBs 110a, 110b (e.g., via the RU 111, the DU 112, and the CU 113) and/or the ng-eNB 114, and/or the LMF 120. As another example, the UE 105, one or more of the gNBs 110a, 110b (e.g., via the RU 111, the DU 112, and the CU 113), and/or the LMF 120 may push the location estimate of the UE 105 to the server 150.

The GMLC 125 may support a location request for the UE 105 received from the external client 130 via the server 150 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130 via the server 150. The GMLC 125 is shown connected to both the AMF 115 and LMF 120, though may not be connected to the AMF 115 or the LMF 120 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 36.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a, 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS or PRS transmissions from the gNBs 110a, 110b, and/or the ng-eNB 114. The LMF 120 may be co-located or integrated with a gNB or a TRP, or may be disposed remote from the gNB and/or the TRP and configured to communicate directly or indirectly with the gNB and/or the TRP.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time of Arrival (ToA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS or PRS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi® AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such implementations, the 5GC 140 may be configured to control different air interfaces. For example, the 5GC 140 may be connected to a WLAN using a Non-3GPP InterWorking Function (N3IWF, not shown FIG. 1) in the 5GC 140. For example, the WLAN may support IEEE 802.11 WiFi® access for the UE 105 and may comprise one or more WiFi® APs. Here. the N3IWF may connect to the WLAN and to other elements in the 5GC 140 such as the AMF 115. In some implementations, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-UTRAN and may use LPP to support positioning of the UE 105. In these other examples, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi® APs, an MME, and an E-SMLC.

As noted, in some examples, positioning functionality may be implemented, at least in part, using the directional SS or PRS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS or PRS beams from a plurality of base stations (such as the gNBs 110a, 110b, the ng-eNB 114, etc.) to compute the position of the UE.

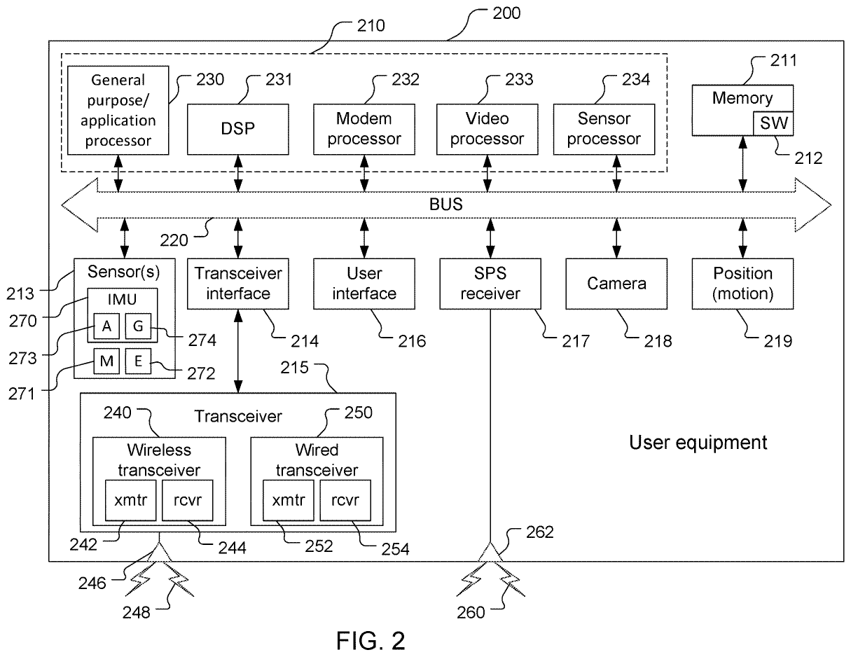

Referring also to FIG. 2, a UE 200 may be an example of one of the UEs 105, 106 and may comprise a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The processor 210, the memory 211, the sensor(s) 213, the transceiver interface 214, the user interface 216, the SPS receiver 217, the camera 218, and the PD 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the UE 200. The processor 210 may include one or more hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 may be a non-transitory storage medium that may include random access memory (RAM), flash memory, disc memory, and/or read-only memory (ROM), etc. The memory 211 may store the software 212 which may be processor-readable, processor-executable software code containing instructions that may be configured to, when executed, cause the processor 210 to perform various functions described herein. Alternatively, the software 212 may not be directly executable by the processor 210 but may be configured to cause the processor 210, e.g., when compiled and executed, to perform the functions. The description herein may refer to the processor 210 performing a function, but this includes other implementations such as where the processor 210 executes software and/or firmware. The description herein may refer to the processor 210 performing a function as shorthand for one or more of the processors 230-234 performing the function. The description herein may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE may include one or more of the processors 230-234 of the processor 210, the memory 211, and the wireless transceiver 240. Other example configurations may include one or more of the processors 230-234 of the processor 210, the memory 211, a wireless transceiver, and one or more of the sensor(s) 213, the user interface 216, the SPS receiver 217, the camera 218, the PD 219, and/or a wired transceiver.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose/application processor 230 and/or the DSP 231. Other configurations, however, may be used to perform baseband processing.

The UE 200 may include the sensor(s) 213 that may include, for example, an Inertial Measurement Unit (IMU) 270, one or more magnetometers 271, and/or one or more environment sensors 272. The IMU 270 may comprise, for example, one or more accelerometers 273 (e.g., collectively responding to acceleration of the UE 200 in three dimensions) and/or one or more gyroscopes 274 (e.g., three-dimensional gyroscope(s)). The sensor(s) 213 may include the one or more magnetometers 271 (e.g., three-dimensional magnetometer(s)) to determine orientation (e.g., relative to magnetic north and/or true north) that may be used for any of a variety of purposes, e.g., to support one or more compass applications. The environment sensor(s) 272 may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the general-purpose/application processor 230 in support of one or more applications such as, for example, applications directed to positioning and/or navigation operations. The sensor(s) 213 may comprise one or more of other various types of sensors such as one or more optical sensors, one or more weight sensors, and/or one or more radio frequency (RF) sensors, etc.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to the LMF 120 regarding the mobility of the UE 200. For example, based on the information obtained/measured by the sensor(s) 213, the UE 200 may notify/report to the LMF 120 that the UE 200 has detected movements or that the UE 200 has moved, and may report the relative displacement/distance (e.g., via dead reckoning, or sensor-based location determination, or sensor-assisted location determination enabled by the sensor(s) 213). In another example, for relative positioning information, the sensors/IMU may be used to determine the angle and/or orientation of the other device with respect to the UE 200, etc.

The IMU 270 may be configured to provide measurements about a direction of motion and/or a speed of motion of the UE 200, which may be used in relative location determination. For example, the one or more accelerometers 273 and/or the one or more gyroscopes 274 of the IMU 270 may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) 273 and the gyroscope(s) 274 taken after this moment in time may be used in dead reckoning to determine present location of the UE 200 based on movement (direction and distance) of the UE 200 relative to the reference location.

The magnetometer(s) 271 may determine magnetic field strengths in different directions which may be used to determine orientation of the UE 200. For example, the orientation may be used to provide a digital compass for the UE 200. The magnetometer(s) may include a two-dimensional magnetometer configured to detect and provide indications of magnetic field strength in two orthogonal dimensions. The magnetometer(s) 271 may include a three-dimensional magnetometer configured to detect and provide indications of magnetic field strength in three orthogonal dimensions. The magnetometer(s) 271 may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to an antenna 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to wired (e.g., electrical and/or optical) signals and from wired (e.g., electrical and/or optical) signals to the wireless signals 248. The wireless transmitter 242 includes appropriate components (e.g., a power amplifier and a digital-to-analog converter). The wireless receiver 244 includes appropriate components (e.g., one or more amplifiers, one or more frequency filters, and an analog-to-digital converter). The wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi®, WiFi® Direct (WiFi®-D), Bluetooth®, Zigbee® etc. New Radio may use mm-wave frequencies and/or sub-6 GHz frequencies. The wired transceiver 250 may include a wired transmitter 252 and a wired receiver 254 configured for wired communication, e.g., a network interface that may be utilized to communicate with the NG-RAN 135 to send communications to, and receive communications from, the NG-RAN 135. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215. The wireless transmitter 242, the wireless receiver 244, and/or the antenna 246 may include multiple transmitters, multiple receivers, and/or multiple antennas, respectively, for sending and/or receiving, respectively, appropriate signals.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose/application processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a GPS receiver) may be capable of receiving and acquiring SPS signals 260 via an SPS antenna 262. The SPS antenna 262 is configured to transduce the SPS signals 260 from wireless signals to wired signals, e.g., electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose/application processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose/application processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS (Complementary Metal-Oxide Semiconductor) imager), a lens, analog-to-digital circuitry, frame buffers, etc. Additional processing, conditioning, encoding, and/or compression of signals representing captured images may be performed by the general-purpose/application processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The PD 219 may be configured to determine a position of the UE 200, motion of the UE 200, and/or relative position of the UE 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer to the PD 219 being configured to perform, or performing, in accordance with the positioning method(s). The PD 219 may also or alternatively be configured to determine location of the UE 200 using terrestrial-based signals (e.g., at least some of the wireless signals 248) for trilateration, for assistance with obtaining and using the SPS signals 260, or both. The PD 219 may be configured to determine location of the UE 200 based on a cell of a serving base station (e.g., a cell center) and/or another technique such as E-CID. The PD 219 may be configured to use one or more images from the camera 218 and image recognition combined with known locations of landmarks (e.g., natural landmarks such as mountains and/or artificial landmarks such as buildings, bridges, streets, etc.) to determine location of the UE 200. The PD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the general-purpose/application processor 230 and/or the DSP 231) may be configured to use to determine motion (e.g., a velocity vector and/or an acceleration vector) of the UE 200. The PD 219 may be configured to provide indications of uncertainty and/or error in the determined position and/or motion. Functionality of the PD 219 may be provided in a variety of manners and/or configurations, e.g., by the general-purpose/application processor 230, the transceiver 215, the SPS receiver 217, and/or another component of the UE 200, and may be provided by hardware, software, firmware, or various combinations thereof.

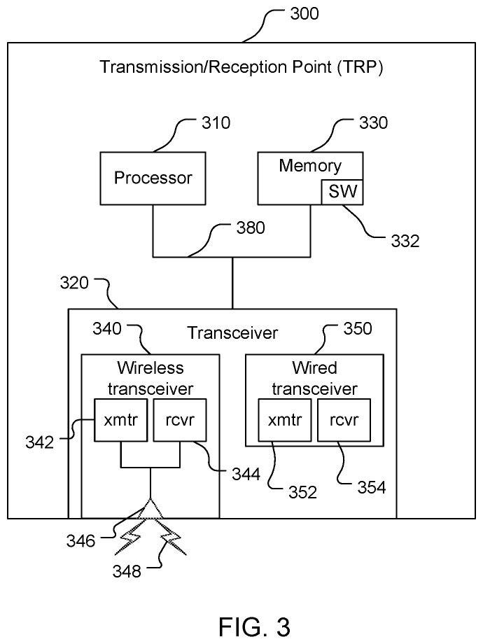

Referring also to FIG. 3, an example of a TRP 300 of the gNBs 110a, 110b and/or the ng-eNB 114 may comprise a computing platform including a processor 310, memory 330 including software (SW) 332, and a transceiver 320. Even if referred to in the singular, the processor 310 may include one or more processors, the transceiver 320 may include one or more transceivers (e.g., one or more transmitters and/or one or more receivers), and the memory 330 may include one or more memories. The processor 310, the memory 330, and the transceiver 320 may be communicatively coupled to each other by a bus 380 (which may be configured, e.g., for optical and/or electrical communication). One or more of the shown apparatus may be omitted from the TRP 300. The processor 310 may include one or more hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 330 may be a non-transitory storage medium that may include random access memory (RAM)), flash memory, disc memory, and/or read-only memory (ROM), etc. The memory 330 may store the software 332 which may be processor-readable, processor-executable software code containing instructions that are configured to, when executed, cause the processor 310 to perform various functions described herein. Alternatively, the software 332 may not be directly executable by the processor 310 but may be configured to cause the processor 310, e.g., when compiled and executed, to perform the functions.

The description herein may refer to the processor 310 performing a function, but this includes other implementations such as where the processor 310 executes software and/or firmware. The description herein may refer to the processor 310 performing a function as shorthand for one or more of the processors contained in the processor 310 performing the function. The description herein may refer to the TRP 300 performing a function as shorthand for one or more appropriate components (e.g., the processor 310 and the memory 330) of the TRP 300 (and thus of one of the gNBs 110a, 110b and/or the ng-eNB 114) performing the function. The processor 310 may include a memory with stored instructions in addition to and/or instead of the memory 330. Functionality of the processor 310 is discussed more fully below.

The transceiver 320 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to wired (e.g., electrical and/or optical) signals and from wired (e.g., electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi®, WiFi® Direct (WiFi®-D), Bluetooth®, Zigbee®, etc. The wired transceiver 350 may include a wired transmitter 352 and a wired receiver 354 configured for wired communication, e.g., a network interface that may be utilized to communicate with the NG-RAN 135 to send communications to, and receive communications from, the LMF 120, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 may be configured to perform or performs several functions, but one or more of these functions may be performed by the LMF 120 and/or the UE 200 (i.e., the LMF 120 and/or the UE 200 may be configured to perform one or more of these functions).

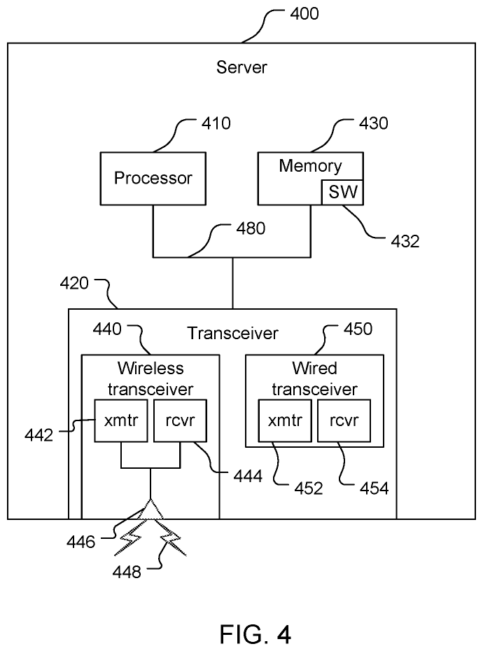

Referring also to FIG. 4, a server 400 (also known as a network entity), of which the LMF 120 may be an example, may comprise a computing platform including a processor 410, memory 430 including software (SW) 432, and a transceiver 420. Even if referred to in the singular, the processor 410 may include one or more processors, the transceiver 420 may include one or more transceivers (e.g., one or more transmitters and/or one or more receivers), and the memory 430 may include one or more memories. The processor 410, the memory 430, and the transceiver 420 may be communicatively coupled to each other by a bus 480 (which may be configured, e.g., for optical and/or electrical communication). One or more of the shown apparatus (e.g., a wireless transceiver) may be omitted from the server 400. The processor 410 may include one or more hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 430 may be a non-transitory storage medium that may include random access memory (RAM)), flash memory, disc memory, and/or read-only memory (ROM), etc. The memory 430 may store the software 432 which may be processor-readable, processor-executable software code containing instructions that are configured to, when executed, cause the processor 410 to perform various functions described herein. Alternatively, the software 432 may not be directly executable by the processor 410 but may be configured to cause the processor 410, e.g., when compiled and executed, to perform the functions. The description herein may refer to the processor 410 performing a function, but this includes other implementations such as where the processor 410 executes software and/or firmware. The description herein may refer to the processor 410 performing a function as shorthand for one or more of the processors contained in the processor 410 performing the function. The description herein may refer to the server 400 performing a function as shorthand for one or more appropriate components of the server 400 performing the function. The processor 410 may include a memory with stored instructions in addition to and/or instead of the memory 430. Functionality of the processor 410 is discussed more fully below.

The transceiver 420 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to wired (e.g., electrical and/or optical) signals and from wired (e.g., electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V 2X (PC5), IEEE 802.11 (including IEEE 802.11p), WiFi®, WiFi® Direct (WiFi®-D), Bluetooth®, Zigbee®, etc. The wired transceiver 450 may include a wired transmitter 452 and a wired receiver 454 configured for wired communication, e.g., a network interface that may be utilized to communicate with the NG-RAN 135 to send communications to, and receive communications from, the TRP 300, for example, and/or one or more other network entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

### Positioning Techniques

For terrestrial positioning of a UE in cellular networks, techniques such as Advanced Forward Link Trilateration (AFLT) and Observed Time Difference Of Arrival (OTDOA) often operate in “UE-assisted” mode in which measurements of reference signals (e.g., PRS, CRS, etc.) transmitted by base stations are taken by the UE and then provided to a location server. The location server calculates the position of the UE based on the measurements and known locations of the base stations.

A UE may use a Satellite Positioning System (SPS) (a GNSS) for high-accuracy positioning using precise point positioning (PPP) or real time kinematic (RTK) technology. These technologies use assistance data such as measurements from ground-based stations. LTE Release 15 allows the data to be encrypted so that the UEs subscribed to the service exclusively can read the information. Such assistance data varies with time. Thus, a UE subscribed to the service may not easily “break encryption” for other UEs by passing on the data to other UEs that have not paid for the subscription. The passing on would need to be repeated every time the assistance data changes.

In UE-assisted positioning, the UE sends measurements (e.g., TDOA, Angle of Arrival (AoA), etc.) to the positioning server (e.g., LMF/eSMLC). The positioning server has the base station almanac (BSA) that contains multiple ‘entries’ or ‘records’, one record per cell, where each record contains geographical cell location but also may include other data. An identifier of the ‘record’ among the multiple ‘records’ in the BSA may be referenced. The BSA and the measurements from the UE may be used to compute the position of the UE.

In UE-based positioning, a UE computes its own position, thus avoiding sending measurements to the network (e.g., location server), which in turn improves latency and scalability. The UE uses relevant BSA record information (e.g., locations of gNBs (more broadly base stations)) from the network. The BSA information may be encrypted. But since the BSA information varies much less often than, for example, the PPP or RTK assistance data described earlier, it may be easier to make the BSA information (compared to the PPP or RTK information) available to UEs that did not subscribe and pay for decryption keys. Transmissions of reference signals by the gNBs make BSA information potentially accessible to crowdsourcing or war-driving, essentially enabling BSA information to be generated based on in-the-field and/or over-the-top observations.

Positioning techniques may be characterized and/or assessed based on one or more criteria such as position determination accuracy and/or latency. Latency is a time elapsed between an event that triggers determination of position-related data and the availability of that data at a positioning system interface, e.g., an interface of the LMF 120. At initialization of a positioning system, the latency for the availability of position-related data is called time to first fix (TTFF), and is larger than latencies after the TTFF. An inverse of a time elapsed between two consecutive position-related data availabilities is called an update rate, i.e., the rate at which position-related data are generated after the first fix. Latency may depend on processing capability, e.g., of the UE. For example, a UE may report a processing capability of the UE as a duration of DL PRS symbols in units of time (e.g., milliseconds) that the UE can process every T amount of time (e.g., T ms) assuming a 272 PRB (Physical Resource Block) allocation. Other examples of capabilities that may affect latency are a number of TRPs from which the UE can process PRS, a number of PRS that the UE can process, and a bandwidth of the UE.

One or more of many different positioning techniques (also called positioning methods) may be used to determine position of an entity such as one of the UEs 105, 106. For example, known position-determination techniques include RTT, multi-RTT, OTDOA (also called TDOA and including UL-TDOA and DL-TDOA), Enhanced Cell Identification (E-CID), DL-AoD, UL-AoA, etc. RTT uses a time for a signal to travel from one entity to another and back to determine a range between the two entities. The range, plus a known location of a first one of the entities and an angle between the two entities (e.g., an azimuth angle) can be used to determine a location of the second of the entities. In multi-RTT (also called multi-cell RTT), multiple ranges from one entity (e.g., a UE) to other entities (e.g., TRPs) and known locations of the other entities may be used to determine the location of the one entity. In TDOA techniques, the difference in travel times between one entity and other entities may be used to determine relative ranges from the other entities and those, combined with known locations of the other entities may be used to determine the location of the one entity. Angles of arrival and/or departure may be used to help determine location of an entity. For example, an angle of arrival or an angle of departure of a signal combined with a range between devices (determined using signal, e.g., a travel time of the signal, a received power of the signal, etc.) and a known location of one of the devices may be used to determine a location of the other device. The angle of arrival or departure may be an azimuth angle relative to a reference direction such as true north. The angle of arrival or departure may be a zenith angle relative to directly upward from an entity (i.e., relative to radially outward from a center of Earth). E-CID uses the identity of a serving cell, the timing advance (i.e., the difference between receive and transmit times at the UE), estimated timing and power of detected neighbor cell signals, and possibly angle of arrival (e.g., of a signal at the UE from the base station or vice versa) to determine location of the UE. In TDOA, the difference in arrival times at a receiving device of signals from different sources along with known locations of the sources and known offset of transmission times from the sources are used to determine the location of the receiving device.

In a network-centric RTT estimation, the serving base station instructs the UE to scan for/receive RTT measurement signals (e.g., PRS) on serving cells of two or more neighboring base stations (and typically the serving base station, as at least three base stations are needed). The one of more base stations transmit RTT measurement signals on low reuse resources (e.g., resources used by the base station to transmit system information) allocated by the network (e.g., a location server such as the LMF 120). The UE records the arrival time (also referred to as a receive time, a reception time, a time of reception, or a time of arrival (ToA)) of each RTT measurement signal relative to the UE's current downlink timing (e.g., as derived by the UE from a DL signal received from its serving base station), and transmits a common or individual RTT response message (e.g., SRS (sounding reference signal) for positioning, i.e., UL-PRS) to the one or more base stations (e.g., when instructed by its serving base station) and may include the time difference T_(Rx→Tx) (i.e., UE TRx-Tx or UERx-Tx) between the ToA of the RTT measurement signal and the transmission time of the RTT response message in a payload of each RTT response message. The RTT response message would include a reference signal from which the base station can deduce the ToA of the RTT response. By comparing the difference T_(Tx→Rx) between the transmission time of the RTT measurement signal from the base station and the ToA of the RTT response at the base station to the UE-reported time difference T_(Rx→Tx), and subtracting the UERx-Tx, the base station can deduce the propagation time between the base station and the UE, from which the base station can determine the distance between the UE and the base station by assuming the speed of light during this propagation time.

A UE-centric RTT estimation is similar to the network-based method, except that the UE transmits uplink RTT measurement signal(s) (e.g., when instructed by a serving base station), which are received by multiple base stations in the neighborhood of the UE. Each involved base station responds with a downlink RTT response message, which may include the time difference between the ToA of the RTT measurement signal at the base station and the transmission time of the RTT response message from the base station in the RTT response message payload.

For both network-centric and UE-centric procedures, the side (network or UE) that performs the RTT calculation typically (though not always) transmits the first message(s) or signal(s) (e.g., RTT measurement signal(s)), while the other side responds with one or more RTT response message(s) or signal(s) that may include the difference between the ToA of the first message(s) or signal(s) and the transmission time of the RTT response message(s) or signal(s).

A multi-RTT technique may be used to determine position. For example, a first entity (e.g., a UE) may send out one or more signals (e.g., unicast, multicast, or broadcast from the base station) and multiple second entities (e.g., other TSPs such as base station(s) and/or UE(s)) may receive a signal from the first entity and respond to this received signal. The first entity receives the responses from the multiple second entities. The first entity (or another entity such as an LMF) may use the responses from the second entities to determine ranges to the second entities and may use the multiple ranges and known locations of the second entities to determine the location of the first entity by trilateration.

In some instances, additional information may be obtained in the form of an angle of arrival (AoA) or angle of departure (AoD) that defines a straight-line direction (e.g., which may be in a horizontal plane or in three dimensions) or possibly a range of directions (e.g., for the UE from the locations of base stations). The intersection of two directions can provide another estimate of the location for the UE.

For positioning techniques using PRS (Positioning Reference Signal) signals (e.g., TDOA and RTT), PRS signals sent by multiple TRPs are measured and the arrival times of the signals, known transmission times, and known locations of the TRPs used to determine ranges from a UE to the TRPs. For example, an RSTD (Reference Signal Time Difference) may be determined for PRS signals received from multiple TRPs and used in a TDOA technique to determine position (location) of the UE. A positioning reference signal may be referred to as a PRS or a PRS signal. The PRS signals are typically sent using the same power and PRS signals with the same signal characteristics (e.g., same frequency shift) may interfere with each other such that a PRS signal from a more distant TRP may be overwhelmed by a PRS signal from a closer TRP such that the signal from the more distant TRP may not be detected. PRS muting may be used to help reduce interference by muting some PRS signals (reducing the power of the PRS signal, e.g., to zero and thus not transmitting the PRS signal). In this way, a weaker (at the UE) PRS signal may be more easily detected by the UE without a stronger PRS signal interfering with the weaker PRS signal. The term RS, and variations thereof (e.g., PRS, SRS, CSI-RS (Channel State Information-Reference Signal)), may refer to one reference signal or more than one reference signal.

Positioning reference signals (PRS) include downlink PRS (DL PRS, often referred to simply as PRS) and uplink PRS (UL PRS) (which may be called SRS (Sounding Reference Signal) for positioning). A PRS may comprise a PN code (pseudorandom number code) or be generated using a PN code (e.g., by modulating a carrier signal with the PN code) such that a source of the PRS may serve as a pseudo-satellite (a pseudolite). The PN code may be unique to the PRS source (at least within a specified area such that identical PRS from different PRS sources do not overlap). PRS may comprise PRS resources and/or PRS resource sets of a frequency layer. A DL PRS positioning frequency layer (or simply a frequency layer) is a collection of DL PRS resource sets, from one or more TRPs, with PRS resource(s) that have common parameters configured by higher-layer parameters DL-PRS-PositioningFrequency Layer, DL-PRS-ResourceSet, and DL-PRS-Resource. Each frequency layer has a DL PRS subcarrier spacing (SCS) for the DL PRS resource sets and the DL PRS resources in the frequency layer. Each frequency layer has a DL PRS cyclic prefix (CP) for the DL PRS resource sets and the DL PRS resources in the frequency layer. In 5G, a resource block occupies 12 consecutive subcarriers and a specified number of symbols. Common resource blocks are the set of resource blocks that occupy a channel bandwidth. A bandwidth part (BWP) is a set of contiguous common resource blocks and may include all the common resource blocks within a channel bandwidth or a subset of the common resource blocks. Also, a DL PRS Point A parameter defines a frequency of a reference resource block (and the lowest subcarrier of the resource block), with DL PRS resources belonging to the same DL PRS resource set having the same Point A and all DL PRS resource sets belonging to the same frequency layer having the same Point A. A frequency layer also has the same DL PRS bandwidth, the same start PRB (and center frequency), and the same value of comb size (i.e., a frequency of PRS resource elements per symbol such that for comb-N, every Nth resource element is a PRS resource element). A PRS resource set is identified by a PRS resource set ID and may be associated with a particular TRP (identified by a cell ID) transmitted by an antenna panel of a base station. A PRS resource ID in a PRS resource set may be associated with an omnidirectional signal, and/or with a single beam (and/or beam ID) transmitted from a single base station (where a base station may transmit one or more beams). Each PRS resource of a PRS resource set may be transmitted on a different beam and as such, a PRS resource (or simply resource) can also be referred to as a beam. This does not have any implications on whether the base stations and the beams on which PRS are transmitted are known to the UE.

A TRP may be configured, e.g., by instructions received from a server and/or by software in the TRP, to send DL PRS per a schedule. According to the schedule, the TRP may send the DL PRS intermittently, e.g., periodically at a consistent interval from an initial transmission. The TRP may be configured to send one or more PRS resource sets. A resource set is a collection of PRS resources across one TRP, with the resources having the same periodicity, a common muting pattern configuration (if any), and the same repetition factor across slots. Each of the PRS resource sets comprises multiple PRS resources, with each PRS resource comprising multiple OFDM (Orthogonal Frequency Division Multiplexing) Resource Elements (REs) that may be in multiple Resource Blocks (RBs) within N (one or more) consecutive symbol(s) within a slot. PRS resources (or reference signal (RS) resources generally) may be referred to as OFDM PRS resources (or OFDM RS resources). An RB is a collection of REs spanning a quantity of one or more consecutive symbols in the time domain and a quantity (12 for a 5G RB) of consecutive sub-carriers in the frequency domain. Each PRS resource is configured with an RE offset, slot offset, a symbol offset within a slot, and a number of consecutive symbols that the PRS resource may occupy within a slot. The RE offset defines the starting RE offset of the first symbol within a DL PRS resource in frequency. The relative RE offsets of the remaining symbols within a DL PRS resource are defined based on the initial offset. The slot offset is the starting slot of the DL PRS resource with respect to a corresponding resource set slot offset. The symbol offset determines the starting symbol of the DL PRS resource within the starting slot. Transmitted REs may repeat across slots, with each transmission being called a repetition such that there may be multiple repetitions in a PRS resource. The DL PRS resources in a DL PRS resource set are associated with the same TRP and each DL PRS resource has a DL PRS resource ID. A DL PRS resource ID in a DL PRS resource set is associated with a single beam transmitted from a single TRP (although a TRP may transmit one or more beams).

A PRS resource may also be defined by quasi-co-location and start PRB parameters. A quasi-co-location (QCL) parameter may define any quasi-co-location information of the DL PRS resource with other reference signals. The DL PRS may be configured to be QCL type D with a DL PRS or SS/PBCH (Synchronization Signal/Physical Broadcast Channel) Block from a serving cell or a non-serving cell.

The DL PRS may be configured to be QCL type C with an SS/PBCH Block from a serving cell or a non-serving cell. The start PRB parameter defines the starting PRB index of the DL PRS resource with respect to reference Point A. The starting PRB index has a granularity of one PRB and may have a minimum value of 0 and a maximum value of 2176 PRBs.

A PRS resource set is a collection of PRS resources with the same periodicity, same muting pattern configuration (if any), and the same repetition factor across slots. Every time all repetitions of all PRS resources of the PRS resource set are configured to be transmitted is referred as an “instance”. Therefore, an “instance” of a PRS resource set is a specified number of repetitions for each PRS resource and a specified number of PRS resources within the PRS resource set such that once the specified number of repetitions are transmitted for each of the specified number of PRS resources, the instance is complete. An instance may also be referred to as an “occasion.” A DL PRS configuration including a DL PRS transmission schedule may be provided to a UE to facilitate (or even enable) the UE to measure the DL PRS.

Multiple frequency layers of PRS may be aggregated to provide an effective bandwidth that is larger than any of the bandwidths of the layers individually. Multiple frequency layers of component carriers (which may be consecutive and/or separate) and meeting criteria such as being quasi co-located (QCLed), and having the same antenna port, may be stitched to provide a larger effective PRS bandwidth (for DL PRS and UL PRS) resulting in increased time of arrival measurement accuracy. Stitching comprises combining PRS measurements over individual bandwidth fragments into a unified piece such that the stitched PRS may be treated as having been taken from a single measurement. Being QCLed, the different frequency layers behave similarly, enabling stitching of the PRS to yield the larger effective bandwidth. The larger effective bandwidth, which may be referred to as the bandwidth of an aggregated PRS or the frequency bandwidth of an aggregated PRS, provides for better time-domain resolution (e.g., of TDOA). An aggregated PRS includes a collection of PRS resources and each PRS resource of an aggregated PRS may be called a PRS component, and each PRS component may be transmitted on different component carriers, bands, or frequency layers, or on different portions of the same band.

RTT positioning is an active positioning technique in that RTT uses positioning signals sent by TRPs to UEs and by UEs (that are participating in RTT positioning) to TRPs. The TRPs may send DL-PRS signals that are received by the UEs and the UEs may send SRS (Sounding Reference Signal) signals that are received by multiple TRPs. A sounding reference signal may be referred to as an SRS or an SRS signal. In 5G multi-RTT, coordinated positioning may be used with the UE sending a single UL-SRS for positioning that is received by multiple TRPs instead of sending a separate UL-SRS for positioning for each TRP. A TRP that participates in multi-RTT will typically search for UEs that are currently camped on that TRP (served UEs, with the TRP being a serving TRP) and also UEs that are camped on neighboring TRPs (neighbor UEs). Neighbor TRPs may be TRPs of a single BTS (Base Transceiver Station) (e.g., gNB), or may be a TRP of one BTS and a TRP of a separate BTS. For RTT positioning, including multi-RTT positioning, the DL-PRS signal and the UL-SRS for positioning signal in a PRS/SRS for positioning signal pair used to determine RTT (and thus used to determine range between the UE and the TRP) may occur close in time to each other such that errors due to UE motion and/or UE clock drift and/or TRP clock drift are within acceptable limits. For example, signals in a PRS/SRS for positioning signal pair may be transmitted from the TRP and the UE, respectively, within about 10 ms of each other. With SRS for positioning being sent by UEs, and with PRS and SRS for positioning being conveyed close in time to each other, it has been found that radio-frequency (RF) signal congestion may result (which may cause excessive noise, etc.) especially if many UEs attempt positioning concurrently and/or that computational congestion may result at the TRPs that are trying to measure many UEs concurrently.

RTT positioning may be UE-based or UE-assisted. In UE-based RTT, the UE 200 determines the RTT and corresponding range to each of the TRPs 300 and the position of the UE 200 based on the ranges to the TRPs 300 and known locations of the TRPs 300. In UE-assisted RTT, the UE 200 measures positioning signals and provides measurement information to the TRP 300, and the TRP 300 determines the RTT and range. The TRP 300 provides ranges to a location server, e.g., the server 400, and the server determines the location of the UE 200, e.g., based on ranges to different TRPs 300. The RTT and/or range may be determined by the TRP 300 that received the signal(s) from the UE 200, by this TRP 300 in combination with one or more other devices, e.g., one or more other TRPs 300 and/or the server 400, or by one or more devices other than the TRP 300 that received the signal(s) from the UE 200.

Various positioning techniques are supported in 5G NR. The NR native positioning methods supported in 5G NR include DL-only positioning methods, UL-only positioning methods, and DL+UL positioning methods. Downlink-based positioning methods include DL-TDOA and DL-AoD. Uplink-based positioning methods include UL-TDOA and UL-AoA. Combined DL+UL-based positioning methods include RTT with one base station and RTT with multiple base stations (multi-RTT).

A position estimate (e.g., for a UE) may be referred to by other names, such as a location estimate, location, position, position fix, fix, or the like. A position estimate may be geodetic and comprise coordinates (e.g., latitude, longitude, and possibly altitude) or may be civic and comprise a street address, postal address, or some other verbal description of a location. A position estimate may further be defined relative to some other known location or defined in absolute terms (e.g., using latitude, longitude, and possibly altitude). A position estimate may include an expected error or uncertainty (e.g., by including an area or volume within which the location is expected to be included with some specified or default level of confidence). Position information may include one or more positioning signal measurements (e.g., of one or more satellite signals, of PRS, and/or one or more other signals), and/or one or more values (e.g., one or more ranges (possibly including one or more pseudoranges), and/or one or more position estimates, etc.) based on one or more positioning signal measurements.

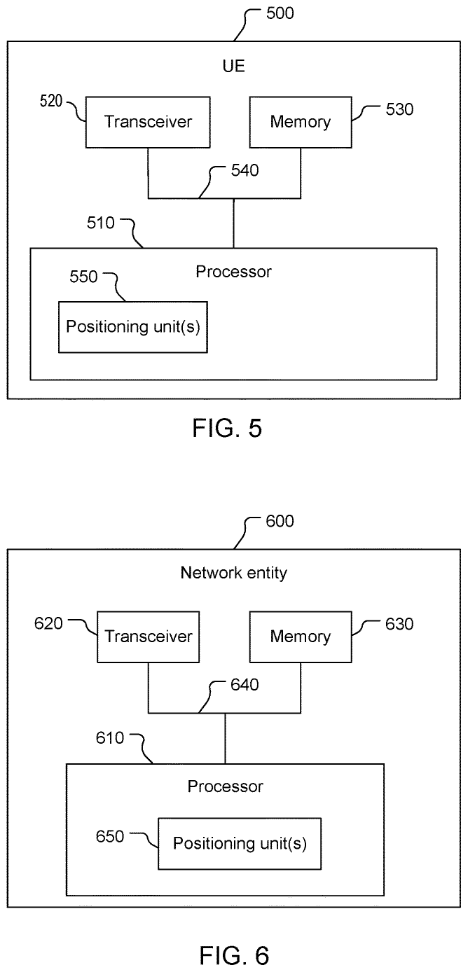

Referring also to FIG. 5, a UE 500 includes a processor 510, a transceiver 520, and a memory 530 in signal communication with each other by a bus 540. Even if referred to in the singular, the processor 510 may include one or more processors, the transceiver 520 may include one or more transceivers (e.g., one or more transmitters and/or one or more receivers), and the memory 530 may include one or more memories. The UE 500 may include the components shown in FIG. 5. The UE 500 may include one or more other components such as any of those shown in FIG. 2 such that the UE 200 may be an example of the UE 500. For example, the processor 510 may include one or more of the components of the processor 210. The transceiver 520 may include one or more of the components of the transceiver 215, e.g., the wireless transmitter 242 and the antenna 246, or the wireless receiver 244 and the antenna 246, or the wireless transmitter 242, the wireless receiver 244, and the antenna 246. Also or alternatively, the transceiver 520 may include the wired transmitter 252 and/or the wired receiver 254. The memory 530 may be configured similarly to the memory 211, e.g., including software with processor-readable instructions configured to cause the processor 510 to perform functions.

The description herein may refer to the processor 510 performing a function, but this includes other implementations such as where the processor 510 executes software (stored in the memory 530) and/or firmware. The description herein may refer to the UE 500 performing a function as shorthand for one or more appropriate components (e.g., the processor 510 and the memory 530) of the UE 500 performing the function. The processor 510 (possibly in conjunction with the memory 530 and, as appropriate, the transceiver 520) may include at least one positioning unit 550 (also known as an at least one positioning device). The at least one positioning unit 550 may be configured to perform positioning operations (e.g., determine position information (e.g., measurements, pseudoranges, position estimates, etc.). The at least one positioning unit 550 is discussed further below, and the description may refer to the processor 510 generally, or the UE 500 generally, as performing any of the functions of the positioning unit 550, with the UE 500 being configured to perform the function(s).

Referring also to FIG. 6, a network entity 600 includes a processor 610, a transceiver 620, and a memory 630 in signal communication with each other by a bus 640. Even if referred to in the singular, the network entity 600 may include one or more network entities, the processor 610 may include one or more processors, the transceiver 620 may include one or more transceivers (e.g., one or more transmitters and/or one or more receivers), and the memory 630 may include one or more memories. The network entity 600 may include the components shown in FIG. 6 and may be configured to be a component of a communication network (e.g., a terrestrial communication network such as a cellular network). The network entity 600 may include one or more other components such as any of those shown in FIG. 4 such that the server 400 may be an example of the network entity 600. For example, the processor 610 may include one or more of the components of the processor 410. The transceiver 620 may include one or more of the components of the transceiver 420. The memory 630 may be configured similarly to the memory 430, e.g., including software with processor-readable instructions configured to cause the processor 610 to perform functions. Also or alternatively, the network entity 600 may include one or more other components such as any of those shown in FIG. 3 such that the TRP 300 may be an example of the network entity 600. For example, the processor 610 may include one or more of the components of the processor 310. The transceiver 620 may include one or more of the components of the transceiver 320. The memory 630 may be configured similarly to the memory 330, e.g., including software with processor-readable instructions configured to cause the processor 610 to perform functions.

The description herein may refer to the processor 610 performing a function, but this includes other implementations such as where the processor 610 executes software (stored in the memory 630) and/or firmware. The description herein may refer to the network entity 600 performing a function as shorthand for one or more appropriate components (e.g., the processor 610 and the memory 630) of the network entity 600 performing the function. The processor 610 (possibly in conjunction with the memory 630 and, as appropriate, the transceiver 620) may include at least one positioning unit 650 (also known as an at least one positioning device). The at least one positioning unit 650 is discussed further below, and the description may refer to the processor 610 generally, or the network entity 600 generally, as performing any of the functions of the positioning unit 650, with the network entity 600 being configured to perform the function(s).

### System for Satellite-based Communication Utilizing Parametrized Satellite Selection

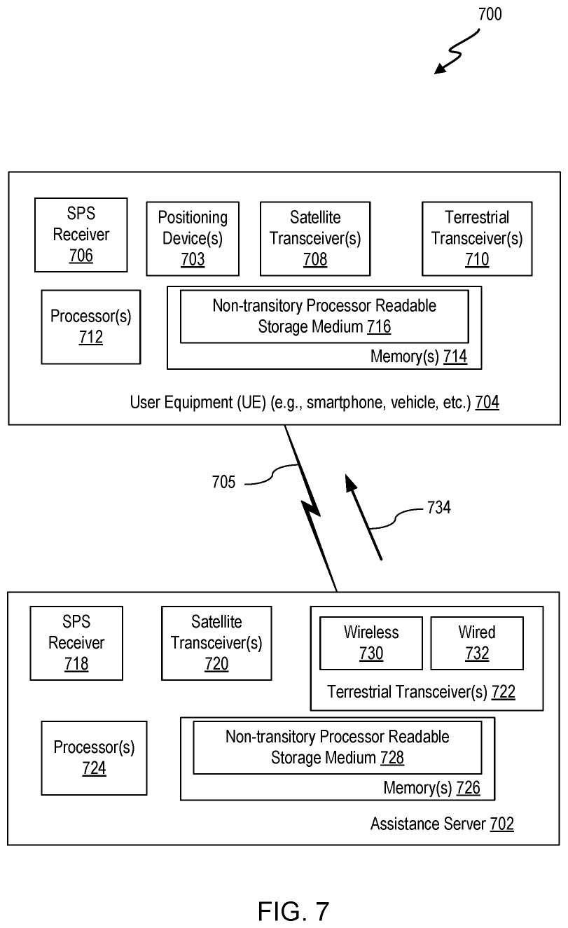

Turning to FIG. 7, a system block diagram is shown of an example of communication system 700 for satellite-based communication. The system 700 includes an assistance server 702 (also known as network entity that includes the functionality described earlier for network entity 600) and a UE 704 that may be, for example, a smartphone, satphone, vehicle, or other mobile device. The server 702 may be in signal communication with the UE 704 via signal path 705. In this example, the UE 704 may include at least one positioning device 703, at least one satellite transceiver 708, at least one terrestrial transceiver 710, at least one processor 712, at least one memory 714 that may include a non-transitory processor-readable storage medium 716. In this example, the positioning device 703 (e.g., the at least one positioning unit 550 discussed earlier) may be, or include, an SPS (e.g., a GNSS) receiver (i.e., SPS receiver 706), a sidelink positioning system, a P2P positioning system, a camera-based positioning system, and/or a non-terrestrial satellite communication system. The assistance server 702 may include an SPS receiver 718 (e.g., the at least one positioning unit 650 discussed earlier), at least one satellite transceiver 720, at least one terrestrial transceiver 722, at least one processor 724, at least one memory 726, and a non-transitory processor-readable storage medium 728 having executable instructions. In this example, the at least one terrestrial transceiver 722 may include a wireless transceiver 730, a wired transceiver 732, or both. The wireless transceiver 730 is configured to communicate via a wireless communication network and the wired transceiver 732 is configured to communicate via a wired communication network. The instructions stored by the non-transitory processor-readable storage medium 716, 728 may be processor-readable, processor-executable software code containing instructions that may be configured to, when executed, cause the at least one processor 712, 724, respectively, to perform various functions described herein. Alternatively, the instructions may not be directly executable by the at least one processor 712, 724 but may be configured to cause the at least one processor 712, 724, e.g., when compiled and executed, to perform the functions. The description herein may refer to the at least one processor 712, 724 performing a function, but this includes other implementations such as where the at least one processor 712, 724 executes software and/or firmware. The description herein may refer to the UE 704 or the assistance server 702, respectively, performing a function as shorthand for one or more appropriate components of the UE 704 or the assistance server 702 performing the function. The at least one processor 712, 724 may include a memory with stored instructions in addition to and/or instead of the at least one memory 714, 726. The functionality of the at least one processors 712, 724 is discussed more fully below.

The assistance server 702 may be configured to provide the UE 704 with assistance information that may be utilized by the at least one satellite transceiver 708 to quickly acquire a satellite for communication. The assistance server 702 may provide this assistance information either via a satellite (e.g., via the at least one satellite transceiver 720) that is in communication with the at least one satellite transceiver 708 or via a terrestrial communication network (e.g., via the at least one terrestrial transceiver 722) that is in communication with the at least one terrestrial transceiver 710. In this example, the at least one terrestrial transceiver 710 may receive the assistance information from the assistance server 702 via a system information block (SIB) broadcast from a cloud server, edge server, gNB/TRP (via SIB), or from another device (e.g., sidelink or P2P communications). In this example, the SPS may be a GNSS such as, for example, GPS, GLONASS, STARLINK®, Galileo, or Beidou or some other local or regional SPS such as the IRNSS, EGNOS, or the WAAS. The at least one satellite transceivers 708 and 720 may be transceivers (or combinations of separate transmitters and receivers) configured to communicate with one or more satellites of a satellite communication system having a LEO satellite constellation such as, for example, the IRIDIUM® and/or GLOBALSTAR® systems. The at least one terrestrial transceiver 710 of the UE 704 may be a wireless (e.g., cellular) transceiver and the at least one terrestrial transceiver 722 of the assistance server 702 may be either a wireless (e.g., cellular) transceiver 730 or a wired transceiver 732 that may communicate with the terrestrial network via landlines.

In general, the assistance server 702 may include a transceiver that may be either the at least one satellite transceiver 720 or the at least one terrestrial transceiver 722, and optionally the SPS receiver 718. The at least one processor 724 may be in signal communication with the transceiver (e.g., the at least one satellite transceiver 720, at least one terrestrial transceiver 722, or both) and the at least one memory 726 and may be configured to perform operations based on instructions stored by the non-transitory processor-readable storage medium 728.

Example operations may include receiving orbital information of the plurality of satellites, generating assistance information 734 from the orbital information, and transmitting the assistance information 734 to the UE 704 via signal path 705. In this example, the assistance information 734 may include at least one condition each comprising a set of parameters and a corresponding indication of one or more satellites, the indication of one or more satellites for at least one of the at least one condition indicating a satellite selection corresponding selecting a satellite other than the nearest satellite. In this example, the SPS receiver 718 is optional and may be utilized by the assistance server 702 to provide additional information in the assistance information 734. In this example, the orbital information, which includes parameters required by the UE 704 to compute satellite positions over time, is generally transmitted from the assistance server 702 to the UE 704. Crowdsourcing information that has been acquired by UEs regarding whether the UEs have been able to communicate with a satellite may be sent from the individual UEs to the assistance server 702. The assistance server 702 may be configured to receive this crowdsourcing information and analyze it to construct or update the conditions, which the server 702 may send to the UE 704.

The at least one processor 712 may be in signal communication with the at least one satellite transceiver 708, the SPS receiver 706, and the at least one memory 714, and may be configured to perform operations based on the instructions stored by the non-transitory processor-readable storage medium 716. The operation may include: receiving, at the UE 704, the assistance information 734 from the assistance server 702, where the assistance information 734 includes parametric conditions for (prioritized) satellite selection for different locations of the UE 704.

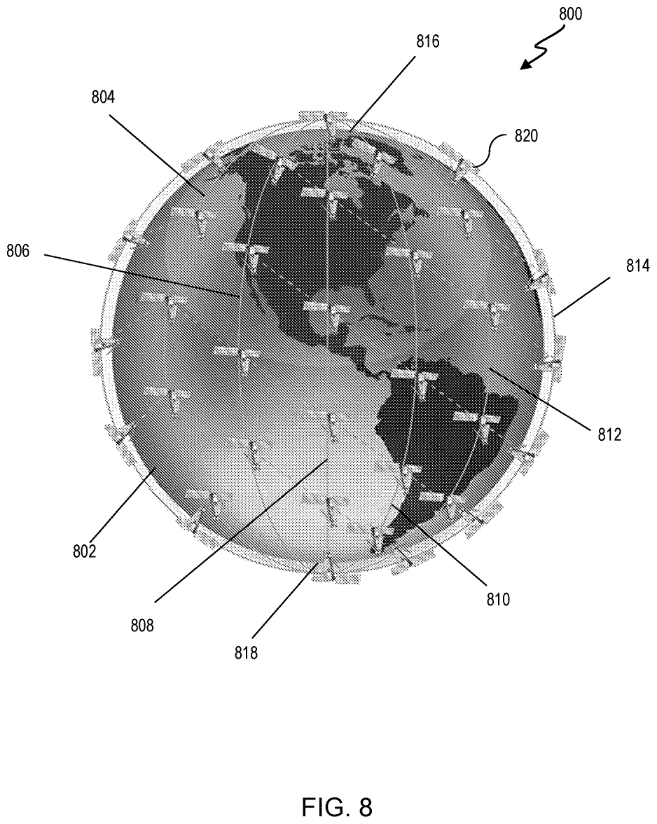

In FIG. 8, a system diagram is shown of a LEO satellite constellation 800 orbiting the Earth 802. In this example, six polar orbits 804, 806, 808, 810, 812, and 814 are shown having orbital planes that pass through the North Pole 816 and South Pole 818 of the Earth 802. The polar orbits 804, 806, 808, 810, 812, and 814 include a plurality of LEO satellites (e.g., LEO satellites 820) traveling along the polar orbits 804, 806, 808, 810, 812, and 814.

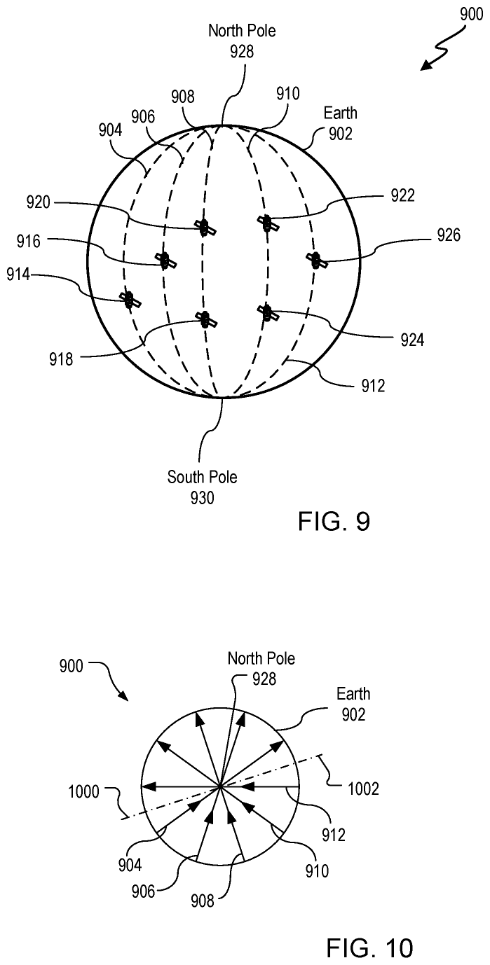

FIG. 9 illustrates a side elevation view showing an example of the LEO satellite constellation 900 (i.e., shown in FIG. 8 as LEO satellite constellation 800) orbiting the Earth 902. However, for ease of illustration, only five orbits 904, 906, 908, 910, and 912 around the Earth 902 are shown in the LEO satellite constellation 900 and only seven LEO satellites 914, 916, 918, 920, 922, 924, and 926. While it is appreciated that each orbit 904, 906, 908, 910, and 912 may include a plurality of LEO satellites, for the purpose of ease of illustration, only one LEO satellite (i.e., LEO satellites 914, 916, and 914) are shown in orbits 904, 906, and 912 and two LEO satellites (i.e., LEO satellites 918, 920, 922, and 924) are shown in orbits 908 and 910. In this example, the LEO satellites 914, 916, 918, 920, 922, 924, and 926 generally include inter-satellite communications capabilities and polar orbital patterns (e.g., polar orbit planes) as shown, where the LEO satellites 914, 916, 918, 920, 922, 924, and 926 travel in the same direction (towards the North Pole 928 or the South Pole 930) for half of the Earth 902. In this example, two LEO satellites 918 and 920 travel in the same direction in the same orbit (i.e., orbit 908) and the other two LEO satellites 922 and 922, in the adjacent orbit (i.e., orbit 910), travel in the same direction as the two LEO satellites 918 and 920.

FIG. 10 illustrates a polar view of the LEO satellite constellation 900 as shown in FIGS. 8 and 9, where FIG. 10 shows that there exist two orbital “seams” 1000 and 1002 in the LEO satellite constellation 900, indicated by the dotted lines, wherein LEO satellites in adjacent orbits are travelling in opposite directions (e.g., counter-rotating planes).

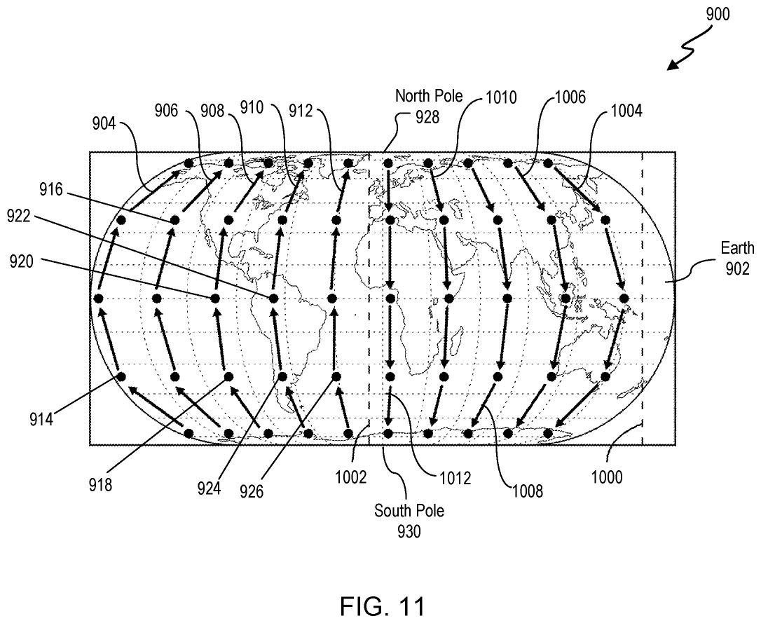

For further clarity, FIG. 11 shows a two-dimensional schematic view of the LEO satellite constellation 900. As described earlier, the orbital seams 1000, 1002 are between adjacent orbits where satellites are moving in opposite directions (e.g., one ascending, moving towards the North Pole 928 and one descending, moving away from the North Pole 928). Generally, satellites in the LEO satellite constellation 900 do not communicate across the seams 1000, 1002 since the inter-satellite link hand-offs have to happen very rapidly and deal with large Doppler shifts. In this example, the plurality of LEO satellites (including LEO satellites 914, 916, 918, 920, 922, 924, and 926) are shown as black dots along the five example orbits 904, 906, 908, 910, and 912 around the Earth 902; and the orbital portions of the orbits 904, 906, 908, 910, and 912 traveling in the southward direction in the approximate eastern hemisphere of the Earth 902 are shown as orbital portions 1004, 1006, 1008, 1010, and 1012, respectively.

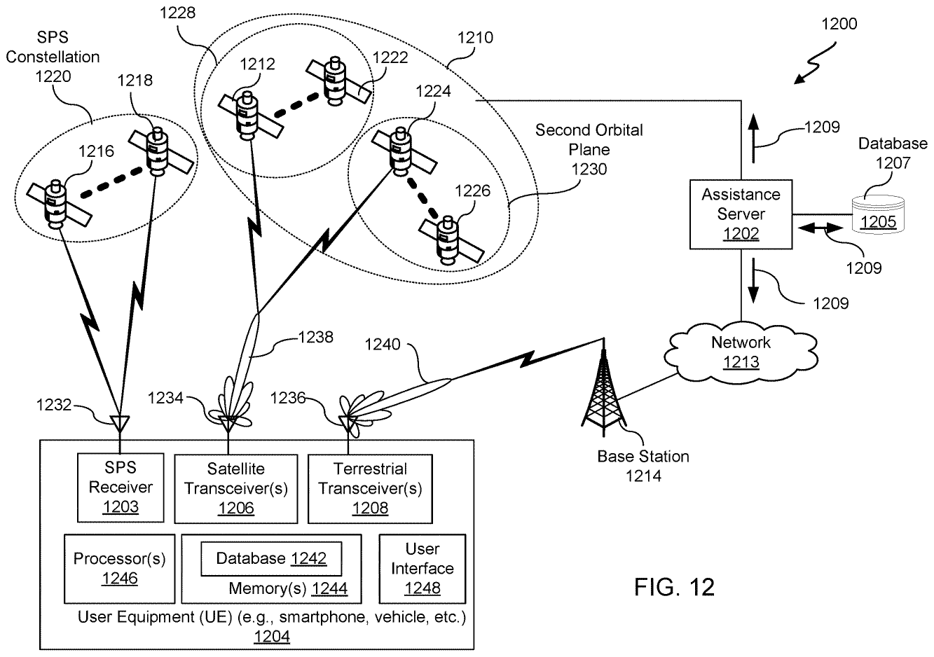

FIG. 12 is a system block diagram of an example system 1200 for satellite-based communication. In this example, the system 1200 includes an assistance server 1202 (that may be an example of the assistance server 702 that may be an example of the network entity 600), a UE 1204 (that may be an example of the UE 105), a storage device 1205 (which may be a part of the assistance server 702), a network 1213, a base station 1214 (which may be a part of the network 1213), an LEO satellite constellation 1210, and an SPS constellation 1220. In this example, the assistance server 1202 may be in signal communication with storage device 1205, the network 1213, base station 1214, LEO satellite constellation 1210, SPS constellation 1220, and UE 1204. The UE 1204 may be in signal communication with the assistance server 1202 and network 1213 via the base station 1214, LEO satellite constellation 1210, and SPS constellation 1220.

The UE 1204 may include a positioning device (e.g., an SPS receiver 1203 and/or other positioning device such as any of those discussed above), at least one satellite transceiver 1206, at least one terrestrial transceiver 1208, an at least one memory 1244 (including a database 1242), an at least one processor 1246, and a user interface 1248. The SPS receiver 1203 may be configured to determine the location of the UE 1204 and a current time from positioning signals received from an SPS constellation (e.g., from satellites 1216, 1218 and/or one or more other satellites of the constellation 1220). The at least one memory 1244 may comprise a non-transitory processor-readable storage medium storing instructions, and the at least one processor 1246 may be in signal communication with the at least one satellite transceiver 1206, the SPS receiver 1203, the at least one terrestrial transceiver 1208, the at least one memory 1244, and the user interface 1248. The user interface 1248 may include one or more mechanisms (e.g., a display and/or a speaker and/or a microphone) for providing information to and/or receiving information from a user. The at least one processor 1246 may be configured to perform operations based on instructions stored by the at least one memory 1244, e.g., as discussed with respect to the at least one processor 1246.

The SPS receiver 1203 may include an SPS antenna 1232 that may omni-directional, while the at least one satellite transceiver 1206 and at least one at least one terrestrial transceiver 1208 may include directional antennas 1234 and 1236, respectively, with directional antenna main lobes 1238 and 1240. The main lobes 1238, 1240 may be directed, e.g., through manipulation of the UE 1204 by a user and/or by beam steering, toward a specific LEO satellite of the LEO satellite constellation 1210 or the base station 1214, respectively. The at least one satellite transceiver 1206 and at least one terrestrial transceiver 1208 may be separate devices configured to communicate with the LEO satellite constellation 1210 and terrestrial communication network 1213 or may be implemented in a single device. As another example, the SPS antenna 1232 and the directional antenna 1234 may be the same antenna, e.g., for L-band operation.

The circuits, components, modules, and/or devices of, or associated with, the systems 700 and 1200 are described, herein, as being in signal communication and/or communicatively coupled with each other, where signal communication refers to any type of communication and/or connection between the circuits, components, modules, and/or devices that allows a circuit, component, module, and/or device to pass and/or receive signals and/or information from another circuit, component, module, and/or device. The communication and/or connection may be along any signal path between the circuits, components, modules, and/or devices that allows signals and/or information to pass from one circuit, component, module, and/or device to another and includes wireless or wired signal paths. The signal paths may be physical, such as, for example, conductive wires, electromagnetic wave guides, cables, attached and/or electromagnetic or mechanically coupled terminals, semi-conductive or dielectric materials or devices, or other similar physical connections or couplings. Additionally, signal paths may be non-physical such as free-space (in the case of electromagnetic propagation) or information paths through digital components where communication information may be passed from one circuit, component, module, and/or device to another in varying digital formats without passing through a direct electromagnetic connection.

In this example, the at least one terrestrial transceiver 1208 may be a cellular or other wireless type of transceiver configured to communicate with the terrestrial communication network (i.e., network 1213) (such as, a cellular or other wireless network) via a base station 1214 that may be a cellular base station located within the cell of cellular telecommunication network. Moreover, the SPS receiver 1203 may be a receiver configured to receive positioning signals from one or more SPS satellites 1216 and 1218 within an SPS constellation 1220. The SPS constellation 1220 may be a GNSS constellation such as, for example, the GPS, the GLONASS, STARLINK®, Galileo, or Beidou or some other local or regional SPS such as the IRNSS, the EGNOS, or the WAAS. The at least one satellite transceiver 1206 may be a transceiver (or a combined transmitter and receiver) configured to communicate with one or more satellites of a satellite communication system having a satellite constellation such as, for example, the IRIDIUM®, STARLINK®, and/or GLOBALSTAR® systems.

As an example, the LEO satellite constellation 1210 is shown to have two pairs of LEO satellites 1212 and 1222 and LEO satellites 1224 and 1226, respectively. The first pair of LEO satellites 1212 and 1222 may be satellites for a first orbital plane 1228 and the second pair of LEO satellites 1224 and 1226 may be satellites for a second adjacent orbital plane 1230.

For ease of illustration, only two SPS satellites 1216 and 1218, and two pairs of LEO satellites 1212 and 1222 and LEO satellites 1224 and 1226 are shown. To obtain a location for the UE 1204 without some type of positional aiding, the SPS receiver 1203 receives positioning signals from at least three SPS satellites for a two-dimensional location and at least four SPS satellites for a three-dimensional location. Moreover, because of the rotation of the Earth and because the LEO satellite constellation 1210 includes a plurality of LEO satellites that are rapidly orbiting Earth, the at least one satellite transceiver 1206 will need to communicate with numerous LEO satellites that will travel across the open sky above the UE 1204. These LEO satellites will come and go based on their respective orbital travel along different orbital planes and the movement of the Earth under these different orbital paths.

The assistance server 1202 may be an example of the assistance server 102. The assistance server 1202 may be configured to receive orbital information and satellite selection parameters based on beam pattern for communication satellites, and produce assistance information 1209 from the orbital information and satellite selection parameters to help the UE 1204 determine an availability of one or more communication satellites with which to attempt to communicate. Different assistance data may be produced and provided to the UE 1204 corresponding to different locations of the UE 1204. The assistance server 1202 may receive orbital information and satellite selection parameters for the satellites from a constellation operator (e.g., via the network 1213). The orbital information and satellite selection parameters may be sent to the assistance server 1202 from a constellation operator that knows, keeps, generates, and updates the orbital information and beam pattern changes for the satellites within the LEO satellite constellation 1210. The assistance server 1202 may store the assistance information 1209 in a database 1207 of the storage device 1205.

Alternatively, or in addition to being configured to receive the orbital information from the constellation operator (e.g., via the network 1213), the assistance server 1202 may be configured to receive orbital and satellite beam availability related information from third-party sources (e.g., via the at least one terrestrial transceiver 1208) that are communicating with and measuring information of the different LEO satellites of the LEO satellite constellation 1210 at different times and locations. This orbital and satellite beam availability related information may be obtained by crowdsourcing using UEs that communicate with the assistance server 1202. These UEs may be field trial devices or individual UEs that are crowd-sourced to produce the information. Over time, the assistance server 1202 may iteratively produce the assistance information 1209 from this received orbital related information. In both of these examples, the assistance information 1209 may include a priori data that will be sent to the UE 1204 for fast acquisition of an LEO satellite of the LEO satellite constellation 1210.

The assistance information 1209 may include one or more conditions for selection of one or more LEO satellites, e.g., prioritized selection of multiple LEO satellites. Each condition may include validity data (e.g., a time interval corresponding to the time interval for when the condition may be assessed, and a latitude range for polar orbits or a latitude range and a longitude range for LEO constellations), satellite criteria for possible satellite selection (e.g., an acceptable satellite range, a satellite direction of travel, an azimuth range relative to a location of the UE 1204, and an elevation range relative to the location of the UE 1204), and one or more indications of satellite availability for selection and use by the UE 1204.

The assistance server 1202 may be configured to help the UE 1204 quickly acquire a satellite, from the LEO satellite constellation 1210, for communication. The assistance server 1202 may provide this assistance information 1209 optionally either via a LEO satellite (e.g., LEO satellite 1212 or 1224) that is in communication with the at least one satellite transceiver 1206 or via the network 1213 that is in signal communication with the at least one terrestrial transceiver 1208 via a base station 1214. If via a LEO satellite, the system 1200 may be configured to provide the assistance information to the UE 1204 when the UE 1204 is communicating with the LEO satellite to update a database 1242 that may be stored on the at least one memory 1244 on the UE 1204. Alternatively, if the assistance server 1202 provides the assistance information 1209 via the network 1213, the at least one terrestrial transceiver 1208 may be a cellular transceiver capable of communicating with the network 1213 via the base station 1214. As an example, the network 1213 may be a wireless network such as a cellular network. The assistance information 1209 may be provided to the UE 1204 for future use, e.g., when the UE 1204 is not actively in communication with any communication satellites.

The at least one processor 1246, e.g., in conjunction with the SPS receiver 1203, may be configured to determine the location of the UE 1204 and a current time, e.g., by receiving this information from the SPS receiver 1203. The at least one processor 1246 may be configured to compute a relative position of each communication satellite (e.g., LEO satellites 1212, 1222, 1224, and 1226) with respect to the location of the UE 1204. The at least one processor 1246 may be configured to use the location of the UE 1204, the locations of the communication satellites, and the assistance information 1209 from the assistance server 1202 to produce a sorted list of candidate communications satellites to provide a prioritized subset of communication satellites based on a likelihood of availability for each satellite. The at least one processor 1246 may be configured to produce directional pointing information based on the sorted list of satellites, e.g., cause the user interface 1248 to prompt a user of the UE 1204 to point a directional antenna 1234 of the at least one satellite transceiver 1206 to an appropriate LEO satellite, or the at least one processor 1246 can directly compute the adjustments required to direct the main lobe of antenna 1234 to align with an appropriate satellite.

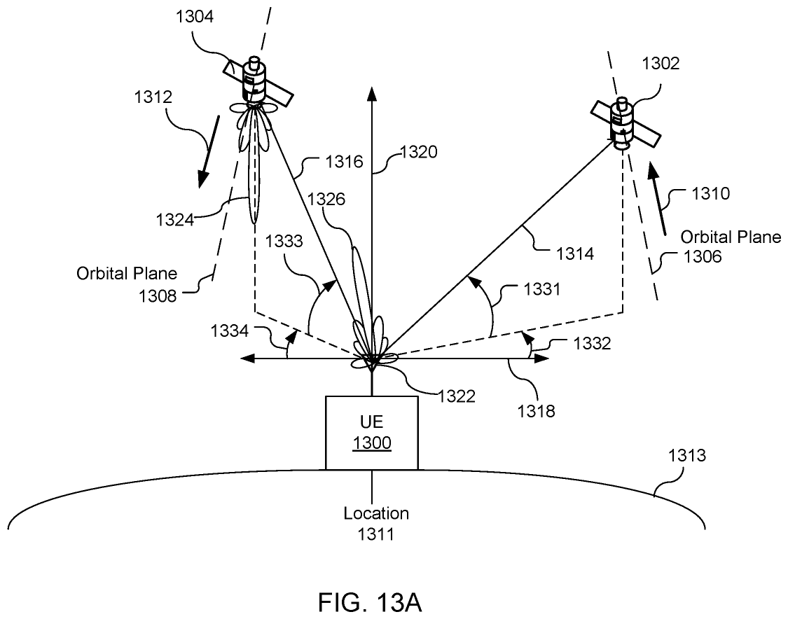

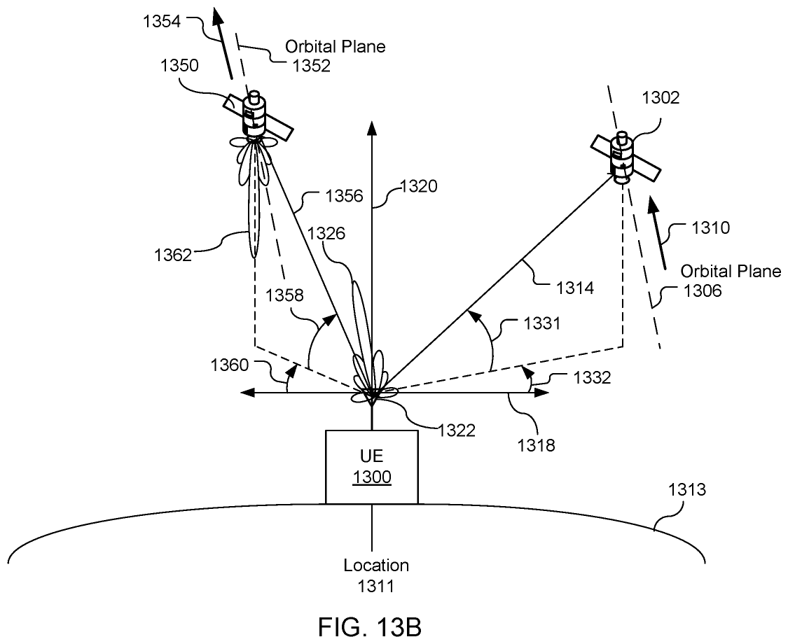

FIG. 13A illustrates a schematic diagram of a UE 1300 (which may be an example of the UE 105) attempting to communicate with either of two LEO satellites 1302, 1304 of an orbital plane 1306 and an orbital plane 1308, respectively at an orbital seam. In this example, the LEO satellite 1302 is shown traveling in a direction of travel 1310 in a south to north direction along the orbital plane 1306 and the LEO satellite 1304 is shown traveling in a direction of travel 1312 in a north to south direction (roughly opposite of the direction of travel 1310) along the orbital plane 1308. In this example, the orbital plane 1306 is a first orbital plane (orbital plane 1) of a six-plane constellation and the orbital plane 1308 is the sixth orbital plane (orbital plane 6) of the six-plane constellation. The UE 1300 is located at a position (i.e., a location 1311 on a surface 1313 of the Earth) that is a first distance 1314 from the LEO satellite 1302 at a first elevation angle 1331 and a first azimuth angle 1332; and a second distance 1316 from the LEO satellite 1304 at a second elevation angle 1333 and a second azimuth angle 1334, respectively. The first azimuth angle 1332 and second azimuth angle 1334 are measured from a horizontal axis 1318 of a Cartesian coordinate system. The first elevation angle 1331 and the second elevation angle 1333 are measured from a horizontal plane (of the Cartesian coordinate system) that includes a horizontal axis 1318 and is normal to the vertical axis 1320. In this example, the horizontal axis 1318 is normal to a boresight of a directional antenna 1322 of the UE 1300. The speeds and directions of travel 1310, 1312 of the LEO satellites 1302, 1304, and the first distance 1314 and second distance 1316, azimuth angle with respect to geographic north or magnetic north may be calculated by the UE 1300 utilizing assistance information provided by the assistance server (i.e., assistance server 102). In this example, the orbital plane 1306 and orbital plane 1308 are in a seam and one of the LEO satellites 1302, 1304 (e.g., the LEO satellite 1302) may have one or more transmission beams in the direction of the location 1311 deactivated (i.e., turned-off), while the other of the LEO satellites 1302, 1304 (e.g., the LEO satellite 1304) may have one or more transmission beams 1324 activated in the direction of the location 1311. The UE 1300, e.g., utilizing the assistance information as discussed herein, may direct a beam of an antenna pattern 1326 of the UE 1300, from the directional antenna 1322, in the direction of the LEO satellite 1304 on the orbital plane 1308. The UE 1300 may produce directional information that may be displayed or communicated to a user of the UE 1300 to physically point the directional antenna 1322 in the direction of the LEO satellite 1304 at approximately the second elevation angle 1333 and second azimuth angle 1334. If the directional antenna 1322 is electronically steerable, the directional information may cause the directional antenna 1322 to electronically steer the antenna pattern 1326 toward the LEO satellite 1304.

FIG. 13B illustrates a schematic diagram of the UE 1300 attempting to communicate with either of two LEO satellites 1302, 1350 of an orbital plane 1306 and an orbital plane 1352, respectively at a non-orbital seam situation. Unlike the example shown in FIG. 13A, in this example, the first LEO satellite 1302 and second satellite 1350 are travelling in the same direction.

The first LEO satellite 1302 is shown traveling in the direction of travel 1310 that is the south to north direction along the orbital plane 1306 and the second LEO satellite 1350 is shown traveling the same direction of travel 1354 as the direction of travel 1310 of the first LEO satellite 1302. The orbital plane 1306 may again be the first orbital plane (i.e., orbital plane 1) of the six-plane constellation and the orbital plane 1352 may be the second orbital plane (i.e., orbital plane 2) of the six-plane constellation. Again, the UE 1300 is located at a position (i.e., a location 1311 on a surface 1313 of the Earth) that is the first distance 1314 from the LEO satellite 1302 at the first elevation angle 1331 and the first azimuth angle 1332; and a second distance 1356 from the second LEO satellite 1350 at a second elevation angle 1358 and a second azimuth angle 1360, respectively. The second elevation angle 1358 is measured from a horizontal plane including the horizontal axis 1318 and the second azimuth angle 1360 is measured from the horizontal axis 1318.

The speeds and directions of travel 1310, 1354 of the LEO satellites 1302, 1350, the first distance 1314, the second distance 1356, and the azimuth angle with respect to geographic north or magnetic north may be calculated by the UE 1300 utilizing assistance information provided by the assistance server. In this example, the orbital plane 1306 and orbital plane 1352 are not in an orbital seam and one or more of the LEO satellites, e.g., the LEO satellite 1302, may have one or more transmission beams in the direction of the location 1311 deactivated (i.e., turned-off), while the second LEO satellite 1350 may have one or more transmission beams 1362 activated in the direction of the location 1311. The UE 1300, e.g., utilizing the assistance information as discussed herein, may direct a beam of an antenna pattern 1326 of the UE 1300, from the directional antenna 1322, in the direction of the second LEO satellite 1350 on the orbital plane 1352. The UE 1300 may produce directional information that may be displayed or communicated to a user of the UE 1300 to physically point the directional antenna 1322 in the direction of the second LEO satellite 1350 at approximately the second elevation angle 1358 and the second azimuth angle 1360. If the directional antenna 1322 is electronically steerable, the directional information may cause the directional antenna 1322 to electronically steer the antenna pattern 1326 toward the LEO satellite 1350.

In this example, transmissions from the first LEO satellite 1302 may be deactivated in order to conserve power and/or to avoid potential problems caused by coverage and/or footprint overlap of both of the LEO satellites 1302, 1350 at the location 1311 of the UE 1300.

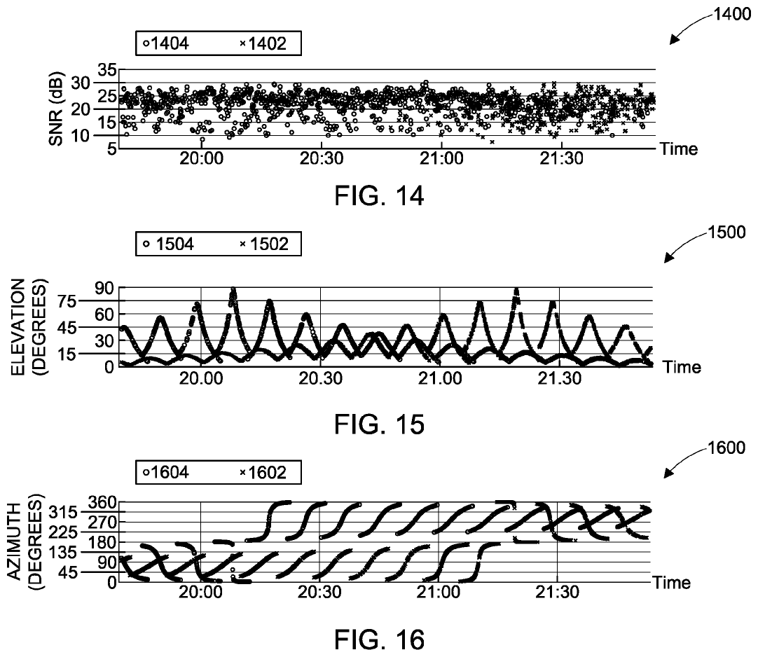

Referring also to FIGS. 14-16, signal characteristics of LEO satellites and locations of LEO satellites vary over time. FIG. 14 is a graph 1400 of signal-to-noise ratio (SNR) values 1402 in decibels versus coordinated universal time (UTC) of signals from satellites in orbital plane 1 of the IRIDIUM-NEXT constellation and SNR values 1404 of signals from satellites in orbital plane 6 of the IRIDIUM-NEXT constellation. FIG. 15 is a graph 1500 of a plot 1502 of elevation angle in degrees versus UTC of satellites in orbital plane 1 of the IRIDIUM-NEXT constellation and a plot 1504 of elevation angle versus UTC of satellites in orbital plane 6 of the IRIDIUM-NEXT constellation. FIG. 16 is a graph 1600 of a plot 1602 of azimuth angle in degrees versus UTC of satellites in orbital plane 1 of the IRIDIUM-NEXT constellation and a plot 1604 of azimuth angle versus UTC of satellites in orbital plane 6 of the IRIDIUM-NEXT constellation. In all of the graphs 1400, 1500, and 1600, the UTC time is approximately a 2-hour window.

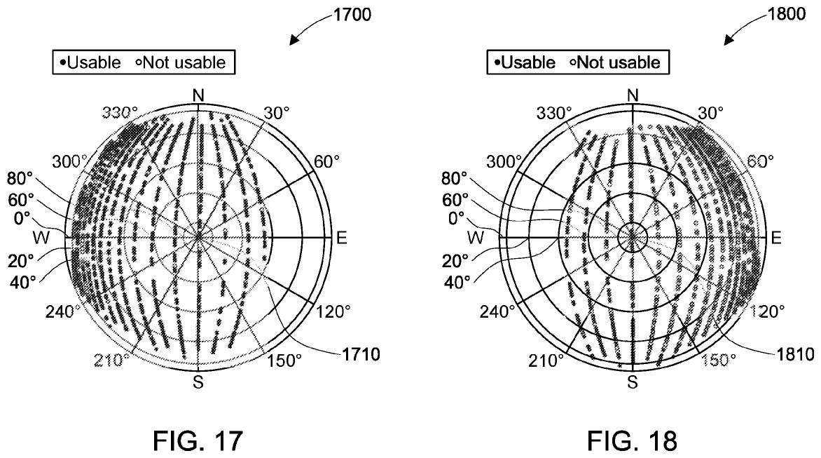

Referring also to FIG. 17 and FIG. 18, LEO satellites vary between being usable and being unusable over time for a fixed location on Earth. In FIG. 17, is a sky plot 1700 of usability of LEO satellites from orbital plane 6 of the IRIDIUM constellation with respect to a location 1710 of a UE. Similarly, in FIG. 18, is a sky plot 1800 of usability of LEO satellites from orbital plane 1 of the IRIDIUM constellation with respect to a location 1810 of a UE. These sky plots 1700 and 1800 show usability of the LEO satellites during same time period from both orbital planes 6 and 1 as the Earth rotates.

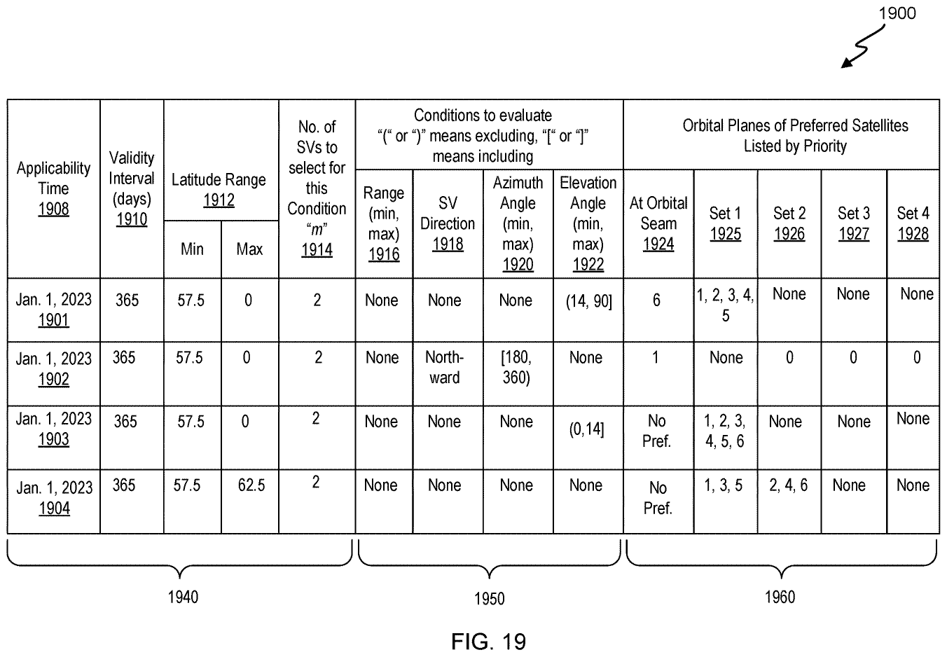

In FIG. 19, a table 1900 of assistance information for use by the UE 1204 (e.g., the UE 500, UE 704 and/or UE 1204) includes validity parameters 1940, satellite parameters 1950, and satellite availability information 1960. The table 1900 is an example of the assistance information 1209 that may be used by the UE 1204, e.g., by applying conditional logic, to select which LEO satellite(s) (e.g., of the LEO satellite constellation 1210) with which to attempt communicate. The assistance information may include one or more parameters corresponding to each of one or more conditions corresponding to a state of the UE 1204 (e.g., location of the UE 1204 and time). In this example, the table 1900 includes four conditions 1901, 1902, 1903, 1904 corresponding to respective rows of the table 1900. Each condition may help filter a set of satellites and may identify one or more satellites from a set of orbital planes for attempted communication with the UE 1204, e.g., prioritizing multiple satellites for attempted communication. Numerous other conditions (e.g., corresponding to different UE locations and/or different times) may be provided, but are not shown in the table 1900. Each condition may be assessed to filter a set of satellites to identify one or more satellites from a set of orbital planes for attempted communication.

The assistance server 1202 may be configured to determine assistance information by identifying parameters of interest and applicable thresholds corresponding to likelihood of successful communication by a UE, e.g., based on UE location relative to satellites. For example, the assistance server 1202 may use orbital information, e.g., locations of satellites and corresponding beam status (e.g., ON/OFF status of each beam of each satellite and the corresponding coverage area on the Earth) and/or locations of satellites (which may be derived from knowledge of orbits and a time) and UE locations and indications of successful/unsuccessful communication by the UE with the satellites, to determine criteria corresponding to likelihood of successful communication by a UE to each of multiple satellites at various locations on the Earth. The server may pack (e.g., compress) this assistance information and send the assistance information to the UE 1204.

The table 1900 is for the satellite constellation from IRIDIUM NEXT that utilizes 66 LEO satellites organized into 11 LEO satellites along 6 polar orbital planes where an orbital seam occurs between orbital planes 1 and 6. As the Earth rotates eastward, this orbital seam moves across the Earth in a western direction such that orbital seam passes over most parts of the Earth twice every 24 hours. The IRIDIUM NEXT constellation is an example, and the discussion herein may be used for other satellite constellations that include polar orbital and non-polar Walker constellations.

Each condition has corresponding values of the validity parameters 1940 indicating how and when the respective condition may be assessed to determine one or more possible satellites with which to attempt to communicate. The validity parameters 1940 in this example include a validity start time 1908 and a validity interval 1910 defining a validity window of time during which the respective condition 1901-1904 is valid (i.e., usable to determine a satellite availability). This is an example, and the validity window may be specified in other ways, e.g., a start time and an end time. The validity parameters 1940 also include an indication of location on the Earth. In this example, the validity parameters include a latitude range 1912 for which the respective condition 1901-1904 is applicable. Multiple conditions may have similar or the same validity parameter values and thus be applicable for the same area of the Earth over the same time window. Alternatively, different conditions may be utilized for different time periods and/or areas of the Earth, e.g., due to changing satellite beam coverage. Also, or alternatively, different conditions may be applicable for the same time to help identify (and possibly prioritize) satellites for attempted communication under various scenarios.

Overlapping conditions, i.e., corresponding to a present UE location and a present time, may be intended by the server 102 to be assessed in order, and the UE 1204 may be configured to assess such conditions (e.g., the conditions 1901-1904) in order, until a desired number of satellites are identified for attempted communication or all of the conditions applicable to a present location of the UE 1204 and a present time are assessed. A maximum satellite vehicle (SV, or simply, satellite) quantity 1914 may be provided that indicates a maximum quantity of SVs for the UE 1204 to select based on the respective condition 1901-1904.

The satellite parameters 1950 provide criteria for potential SVs to meet to be considered for selection for attempted communication by the UE 1204. For example, the satellite parameters 1950 include a range minimum and maximum 1916, an SV direction 1918, an azimuth angle range 1920, and an elevation angle range 1922. One or more of these parameters may be omitted and/or one or more other parameters may be included in the satellite parameters 1950, e.g., as determined by the assistance server 1202 as being of use in selecting satellites with which the UE 1204 likely can communicate (e.g., to optimize satellite selection for different UE locations and corresponding relative locations and movements of satellites). The range minimum and maximum 1916 may define a window of distances from the UE location to a respective SV for the SV to be considered for selection for attempted communication with the UE 1204. The SV direction 1918 may indicate a direction of travel (e.g., northward, southward) for a respective SV to be considered for selection for attempted communication with the UE 1204. The azimuth angle range 1920 may indicate a range of azimuth angles relative to the UE location in which a respective SV must be to be considered for selection for attempted communication with the UE 1204. The elevation angle range 1922 may indicate a range of elevation angles relative to the UE location in which a respective SV must be to be considered for selection for attempted communication with the UE 1204.

The satellite availability information 1960 includes one or more indications of satellite availability for satellite selection for attempted communication by the UE 1204. The satellite availability information 1960 may indicate a priority for attempted satellite communication, e.g., a preferred communication satellite orbital plane in an orbital seam and/or sets of communication satellites ordered according to a priority of attempted communication. Thus, the satellite availability information 1960 may include an orbital seam preference 1924, and set indications 1925, 1926, 1927, 1928. This is an example, and other configurations of satellite availability information may be used. For example, fewer than the four set indications 1925-1928 may be included. The orbital seam preference 1924 which orbital plane of the orbital planes forming an orbital seam is to be considered, e.g., to which of the two orbital planes an SV must belong to be considered for attempted communication by the UE 1204. Each of the set indications 1925-1926 indicates one or more orbital planes of communication satellites to be considered, e.g., for the UE 1204 to assess to determine if the SV(s), if any, meeting the satellite parameters 1950 of the respective condition belongs to an indicated orbital plane. If multiple satellites meet the satellite parameters 1950 and satellite availability information 1960, then UE 1204 may prioritize the satellites based on the order of the sets and within the sets based on the distances from the UE 1204 to the satellites.

In this example, three of the conditions 1901, 1902, 1903 shown in the table 1900 each corresponds to a decision zone, e.g., an orbital seam; however, the fourth condition 1904 corresponds to SV selection logic where there is no preference between satellites in an orbital seam but there is a preference in the decision zone based on an orbital plane (i.e., even or old plane). The example in the condition 1904 illustrates that if the SV latitude range is within 57.5° and 62.5°, none of the satellite parameters 1950 need to be evaluated and the decision is to select odd plane satellites in set 1 per the set indication 1925 and even plane satellites in set 2 per the set indication 1926. In this example, the decision zone is the latitude range between 57.5° and 62.5°.

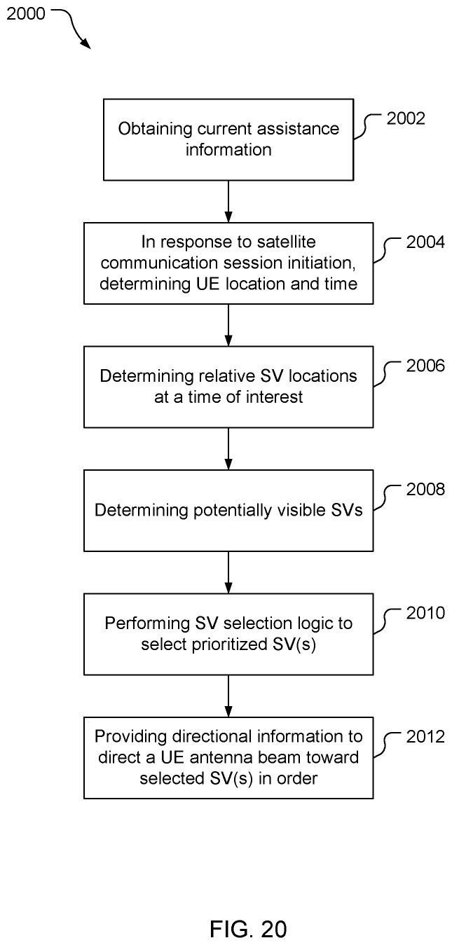

Referring to FIG. 20, with further reference to FIGS. 7-19, a method 2000 for attempting communication with one or more SVs of a set of SVs for attempted communication includes the stages shown. The method 2000 is, however, an example only and not limiting. The method 2000 may be altered, e.g., by having one or more stages added, removed, rearranged, combined, performed concurrently, and/or having one or more single stages split into multiple stages.

At stage 2002, the method 2000 includes obtaining current assistance information. For example, the UE 1204 may obtain the assistance information 1209 (e.g., the table 1900) from the assistance server 1202 with up-to-date parameters for use in selecting satellites for potential communication. The UE 1204 may, for example, obtain the assistance information when the UE 1204 is connected to a terrestrial network, e.g., the network 1213, and/or in a satellite communication session.

At stage 2004, the method 2000 includes, in response to satellite communication session initiation, determining UE location and time. For example, the UE 1204 is not in a present satellite communication session (e.g., if the assistance information was obtained in a satellite communication session, then that session has terminated), and a satellite communication session is initiated, e.g., by a user operating the user interface 1248 to initiate a call, then the UE 1204, e.g., the at least one processor 1246, may obtain a location of the UE 1204, e.g., from the SPS receiver 1203 or by processing information from the SPS receiver 1203. The at least one processor 1246 may also receive an indication of a present time from the SPS receiver 1203 and/or derive the present time from information from the SPS receiver 1203.

At stage 2006, the method 2000 includes determining relative SV locations at a time of interest. The time of interest may be the present time or another time, e.g., a future time. The UE 1204, e.g., the at least one processor 1246, may select the time of interest and may use orbital information to determine positions of SVs corresponding to the time of interest. The UE 1204 may use these SV positions to determine SV positions, corresponding to the time of interest, relative to the UE location.

At stage 2008, the method 2000 includes determining potentially visible SVs. Based on the SV positions determined at stage 2006, the UE 1204 may determine which SVs are potentially visible (possibly in line of sight (LOS)), e.g., not below the horizon relative to the UE 1204. The UE 1204 may or may not consider topological information to determine which SVs are potentially visible. The UE 1204 has respective ranges (distances) to the potentially visible SVs from stage 2006.

At stage 2010, the method 2000 includes performing SV selection logic to select one or more SVs to which the UE 1204 may attempt to communicate (e.g., attempt in a prioritized order). The UE 1204 may use the potentially-visible SVs, e.g., sorted by distance from nearest to furthest, the UE location, the time of interest, and satellite parameters (e.g., relative position of the satellite to the UE location, satellite direction of travel) as inputs to the SV selection logic and may output an SV list of one or more target SVs sorted by likelihood of availability for communication, from most likely to least likely. The UE 1204 may determine whether there is one or more potentially-visible satellites in a decision zone (e.g., a region on the Earth where one or more potentially-visible satellites are unavailable for communication with the UE, e.g., an orbital seam or other region where one or more satellite beams are deactivated (e.g., due to overlapping or potentially overlapping coverage of beams in the region)). Potentially-visible satellites may be satellites above a horizon from a present UE location (or above a threshold angle above the horizon), but may not be visible to the UE, e.g., due to objects such as mountains, trees, buildings, etc. In the case of potentially overlapping beams at the decision zone, the conditions described early in table 1900 may optionally include an additional condition that may utilize a probability of overlap within the decision zone to further differentiate a satellite for the satellite selection indication based on an estimate of whether the beam of that satellite will overlap with one or more beams of one or more other satellites in the decision zone. The probability of overlap may be determined from a number of factors including the proximity of the adjacent orbital paths to the decision zone (e.g., above a threshold latitude value such 57°), the movement of satellites along respective orbital paths, and knowledge of whether one or more potentially-visible satellites have deactivated one or more respective beams to avoid beam overlap at the decision zone. The UE 1204 may obtain, e.g., by retrieving from the at least one memory 1244, a target SV list size indicating a maximum number, M, of SVs to include in the SV list. The SV selection logic may include identifying one or more conditions, from assistance information such as the table 1900, that are applicable to the time of interest and the UE location. The UE 1204 may assess the condition(s) in order until a quantity of identified SVs equals the target SV list size or all of the applicable conditions have been assessed. To assess a condition, the UE 104 may identify any SVs, arranged by distance from nearest to furthest, up to the lesser of the maximum SV quantity 1914 for the respective condition or a quantity of SVs presently available in the input SV list size but are not presently in the target SV list. The UE 1204 may determine which, if any, of the identified SVs meet the satellite parameters 1950, which may be called candidate SVs. If any of the candidate SVs are in an orbital plane of an orbital seam, and if the presently-assessed condition indicates a preferred orbital plane in the orbital seam preference 1924, then the UE 1204 may select the nearest candidate UE(s), if any, in the preferred orbital plane (subject to the quantity limit discussed above, i.e., to fill available SV target list spots up the maximum SV quantity 1914). If there are still available SV target list spots and the maximum SV quantity 1914 has not been reached for this condition, then the UE 1204 may proceed to assess the set indications 1925-1928 in order and assess the orbital plane(s) in order in each of the set indications 1925-1928 to select one or more SVs (nearest to furthest) for attempted communication. Thus, if the plane number of one or more remaining candidate satellites match any of the orbital plane numbers in an assessed set, then that/those candidate satellite(s) may be selected and included in the target SV list in the order of the candidates (e.g., nearest to furthest). The UE 104 may determine whether the maximum SV quantity 1914 of the candidate SVs have been mapped to the target SV list for this condition. If not, then the UE 1204 may assess the same condition again, e.g., for further one(s) of the set indications 1925-1928, with the remaining candidate SVs. If so, then the UE 1204 may proceed to assess the next condition. The UE 1204 may assess one or more further applicable conditions, in order, until the maximum number, M, of SVs for the target SV list has been reached or all conditions have been assessed.

At stage 2012, the method 2000 includes providing directional information to direct a UE antenna beam toward the selected SV(s) in order. For example, the UE 104 may provide directional information through the user interface 1248 to guide a user to point an antenna beam of the UE 1204 toward a highest-priority SV in the target SV list (e.g., most likely to be available, or closest satellite that is most-likely to be visible and available (or equally-likely to be visible and available as another satellite that is further away)). As another example, the UE 1204 may provide directional information to the at least one satellite transceiver 1206 to cause the directional antenna 1234 to steer toward the highest-priority SV in the target SV list. The UE 1204 may transmit one or more communication signals for the selected SV and/or listen for one or more communication signals from the selected SV, in this example the highest-priority SV in the target list, in an attempt to communicate with (establish communication with) the selected SV. If communication is established with this SV, then the UE 1204 may ignore the rest of the target SV list. If communication is not established with this SV, then the UE 1204 may provide directional information to direct the UE antenna beam to the next-highest-priority SV in the target SV list and transmit one or more communication signals to and/or listen for one or more communication signals from the selected SV, in an attempt to communicate with (establish communication with) the selected SV. The UE 104 may continue to try SVs in order in the target SV list until communication is established or there are no more SVs in the target SV list to try. The target SV list is thus a list of SVs with which the UE 1204 may attempt to communicate, and the UE 1204 may not attempt to communicate with any SV in the target SV list of lower priority than an SV with which the UE 1204 successfully communicates. Attempting communication using the target SV list may reduce time and/or power used by the UE 1204 to establish communication with a communication SV.

An example of the SV selection logic of stage 2010 is discussed below in view of the example assistance information provided in the table 1900. The UE 1204 may assess the conditions 1901-1904 in numerical order until the target SV list size is reached. For this example, the UE 1204 is located within the latitude range 1912 between 57.5° and 0°, and that the time of interest is within 365 days (as specified by the validity interval 1910) of Jan. 1, 2023 (as specified by the validity time). The UE 1204 may determine up to two (2) SVs for the target SV list using the condition 1901 as specified by the maximum SV quantity 1914 parameter. The UE 1204 may determine which SVs are potentially visible at the present UE location and the time of interest and that are within an elevation range from 14° (here, exclusive) to 90° (here, inclusive). If satellites from both orbital planes in a decision zone (e.g., an orbital seam) are potentially visible at the present UE location and one or more of the candidate SVs (meeting the elevation range) are in an orbital seam plane (in this example, plane 1 or plane 6), then the UE 1204 will ignore the candidate SV(s) in plane 1 and select one or more candidate SV(s), if any, in plane 6 based on the orbital seam preference 1924 indicating plane 6. If the maximum SV quantity 1914 has not been reached, and there are any available slots in the target SV list after evaluating the orbital seam preference, then the UE 1204 may assess the orbital planes indicated in the set indication 1925 for satellites to include in the SV target list. If there is still availability in the target SV list, because the set indications 1926-1928 indicate no orbital planes, then the UE 1204 may proceed to assess the condition 1902 with satellites remaining from the input list (not part of the output SV target list). For the condition 1902, the UE 1204 may determine whether there are any available satellites moving in the northward direction as indicated by the SV direction 1918 parameter and between azimuth angles of 180° (here, inclusive) and 360° (here, exclusive). If satellites from both orbital planes of an orbital seam are potentially visible at the present UE location and one or more of the remaining candidate SVs (meeting the satellite parameters 1950 of the condition 1902) are in an orbital seam plane, then the UE 1204 will ignore the candidate SV(s) in plane 6 and select one or more candidate SV(s), if any, in plane 1 based on the orbital seam preference 1924 of the condition 1902 indicating plane 1. In this example, there are no available slots in set indications 1925-1928 of the condition 1902. If the maximum SV quantity 1914 has not been reached, because the set indications 1925-1928 indicate no orbital planes, then the UE 1204 may proceed to assess the condition 1903. For the condition 1903, the UE 1204 may determine which SVs are potentially visible at the present UE location and the time of interest and that are within an elevation range from 0° (here, exclusive) to 14° (here, inclusive). If satellites from both orbital planes of a decision zone (in this example an orbital seam) are potentially visible at the present UE location and one or more of the candidate SVs (meeting the elevation range) are in an orbital seam, then the UE 1204 will select any candidate SV(s) sorted by distance to the UE 1204 in ascending order because there is no preference in orbital seam preference 1924. Since there is no preference, the UE 104 may select any satellite for orbital planes 1-6 in set 1 sorted by distance to the UE 104 in ascending order per the set indication 1925.

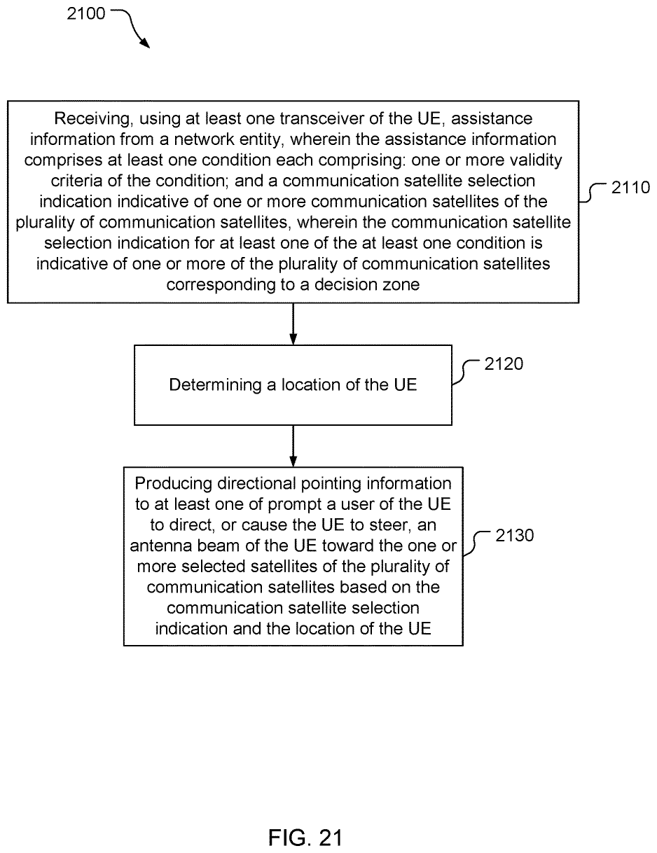

Referring to FIG. 21, with further reference to FIGS. 7-19, a method 2100 for providing pointing information associated with a UE includes the stages shown. The method 2100 is, however, an example only and not limiting. The method 2100 may be altered, e.g., by having one or more stages added, removed, rearranged, combined, performed concurrently, and/or having one or more single stages split into multiple stages.

At stage 2110, the method 2100 includes receiving, at the UE, assistance information from a server, wherein the assistance information comprises at least one condition each comprising: one or more validity criteria of the condition; and a communication satellite selection indication indicative of one or more communication satellites of the plurality of communication satellites, wherein the communication satellite selection indication for at least one of the at least one condition is indicative of one or more of the plurality of communication satellites corresponding to a decision zone. In the decision zone, multiple communication satellites are potentially visible (e.g., above a threshold angle above the horizon) and thus the UE has a decision of with which satellite to attempt communication, at least first. A beam of one of the satellites may be disabled such that communication with that satellite from the decision zone is unavailable. The beam of one satellite may overlap with a beam of another satellite (if both beams were concurrently active) in the decision zone. As an example, the decision zone may correspond to an orbital seam or another location of the UE at which a potentially-visible satellite in one orbit may have a deactivated communication beam, e.g., to avoid overlapping coverage and/or to conserve power, e.g., such that a nearest visible satellite may not be the preferred satellite with which to attempt to communicate. Typically, this second example (where a satellite other than the nearest visible satellite may be preferred for attempting communication) corresponds to the UE being located at higher latitudes where multiple polar orbital planes can be visible to a UE at the same time. An indication of one or more communication satellites corresponding to the decision zone may be, for example, be an indication of one or more orbital planes (e.g., a preferred orbital plane, a set of orbital planes, multiple prioritized sets of orbital planes with each set indicating at least one orbital plane).

The UE 1204 may receive the assistance information 1209, e.g., the table 1900, from the assistance server 1202, e.g., through a terrestrial network such as the network 1213 and/or via a satellite. The at least one processor 1246, possibly in combination with the at least one memory 1244, in combination with the at least one terrestrial transceiver 1208 and/or the at least one satellite transceiver 1206, may comprise means for receiving assistance information.

At stage 2120, the method 2100 includes determining a location of the UE. For example, a positioning device may determine a position estimate for the UE from positioning signals. The positioning device may be, for example, the SPS receiver 1203 and the positioning signals may be positioning signals from SPS satellites. As other examples, the positioning device may be sidelink positioning system, a P2P positioning system, a camera-based positioning system, and/or a non-terrestrial satellite communication system, etc. For example, the SPS receiver 1203 may provide a location of the UE 1204 and/or may provide SPS signal measurements from which the at least one processor 1246 may determine the UE location. The SPS receiver 1203 and/or the at least one processor 1246, possibly in combination with the at least one memory 1244, may comprise means for determining the location of the UE.

At stage 2130, the method 2100 includes producing directional pointing information to at least one of prompt a user of the UE to direct, or cause the UE to steer, an antenna beam of the UE toward one of one or more selected satellites of the plurality of communication satellites based on the communication satellite selection indication and the location of the UE. For example, at stage 2012, the at least one processor 1246 may provide directional information through the user interface 1248 to guide a user to point an antenna beam of the UE 1204 toward a highest-priority SV in the target SV list. As another example, the UE 1204 may provide directional information to the at least one satellite transceiver 1206 to cause the directional antenna 1234 to steer toward the highest-priority SV in the target SV list. The at least one processor 1246, possibly in combination with the at least one memory 1244, may comprise means for producing the directional pointing information.

Implementations of the method 2100 may include one or more of the following examples. In an example implementation, the method 2100 includes determining a preferred satellite corresponding to the decision zone based on the communication satellite selection indication. For example, the at least one processor 1246 may use the target SV list to identify a preferred satellite with which to attempt communication with the UE in the decision zone (e.g., an orbital seam or latitude near the north pole or near the south pole for polar orbits). The at least one processor 1246, possibly in combination with the at least one memory 1244, may comprise means for determining the preferred satellite.

Also, or alternatively, implementations of the method 2100 may include one or more of the following features. In an example implementation, the decision zone corresponds to an orbital seam. In another example implementation, the decision zone is a latitude range (e.g., near a pole). In another example implementation, the communication satellite selection indication is an indication of an orbital plane. In another example implementation, each condition further comprises one or more satellite criteria for a satellite of the plurality of communication satellites to satisfy in order to be a candidate satellite that is considered for use by the UE for communication. For example, each condition may include one or more of the satellite parameters 1950. In a further example implementation, the one or more satellite criteria include: a satellite distance range with respect to the location of the UE; a satellite direction of travel; an azimuth angle range from the location of the UE; an elevation angle range from the location of the UE; or any combination of two or more thereof. For example, the one or more criteria may include the satellite distance range and the satellite direction of travel, and/or may include the azimuth angle range and the elevation angle range. For example, each of the conditions 1901-1903 includes the satellite parameters 1950. In another example, the satellite parameters 1950 may be set to “None” and the satellite availability information 1960 assists in selecting between satellites in different orbital planes as long as the satellites are visible to the UE. In another example implementation, the method 2100 includes determining a position, relative to the UE, of each candidate satellite. For example, at stage 2006, the at least one processor 1246 may determine, based on SV positions and the UE location, elevation angles, azimuth angles, and distances from the UE location to SVs that are potentially visible from the UE location. The at least one processor 1246, possibly in combination with the at least one memory 1244, may comprise means for determining the position of each candidate satellite. In another example implementation, the method 2100 includes determining candidate satellites of the plurality of communication satellites that satisfy the one or more satellite criteria. For example, at stage 2008 and stage 2010, the at least one processor 1246 may determine potentially visible SVs from the UE location and determine which of the potentially visible SVs satisfy one or more satellite criteria, e.g., the satellite parameters 1950. The at least one processor 1246, possibly in combination with the at least one memory 1244, may comprise means for determining candidate satellites. In another example implementation, producing the directional pointing information to at least one of prompt the user of the UE to direct, or cause the transceiver to steer, the antenna beam of the transceiver toward each of the one or more selected satellites comprises producing the directional pointing information to at least one of prompt the user of the UE to direct, or cause the transceiver to steer, the antenna beam of the transceiver toward each of the one or more selected satellites in an order based on a likelihood of availability for each of the one or more selected satellites. In another example implementation, the one or more validity criteria comprise: a at least one of a latitude indication of a latitude range of the UE for the respective condition and longitude indication of a longitude range of the UE for the respective condition; and a time indication of a time range for the respective condition. For example, each of the conditions 1901-1903 includes the validity parameters 1940 including an applicability time 1908, the validity interval 1910, and the latitude range 1912. As an example, a latitude and/or longitude range may be utilized for non-polar LEO satellite orbits).

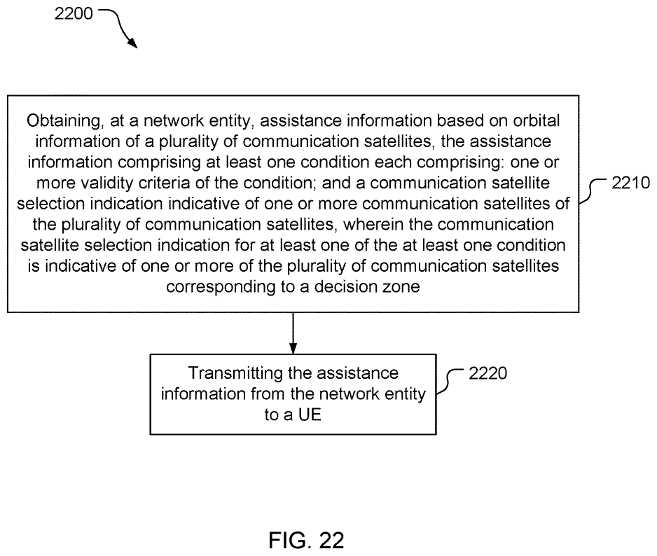

Referring to FIG. 22, with further reference to FIGS. 7-19, a method 2200 for providing assistance information includes the stages shown. The method 2200 is, however, an example only and not limiting. The method 2200 may be altered, e.g., by having one or more stages added, removed, rearranged, combined, performed concurrently, and/or having one or more single stages split into multiple stages.

At stage 2210, the method 2200 includes obtaining, at a server, assistance information based on orbital information of a plurality of communication satellites, the assistance information comprising at least one condition each comprising: one or more validity criteria of the condition; and a communication satellite selection indication indicative of one or more communication satellites of the plurality of communication satellites, wherein the communication satellite selection indication for at least one of the at least one condition is indicative of one or more of the plurality of communication satellites corresponding to a decision zone. For example, the assistance server 1202, or other network entity, may produce, aggregate, and/or reprocess the assistance information 1209 such as the table 1900, including the validity parameters 1940 and the satellite availability information 1960. The assistance server 1202 may obtain the assistance information from satellite orbital information (and satellite beam availability information), e.g., received from a constellation owner and/or crowd-sourced UE location and beam availability information. The at least one processor 1246, possibly in combination with the at least one memory 1244, possibly in combination with the at least one satellite transceiver 1206 and/or the at least one terrestrial transceiver 1208, may comprise means for obtaining the assistance information.

At stage 2220, the method 2200 includes transmitting the assistance information from the server to a UE. For example, at stage 2002, the assistance server 1202 may transmit the assistance information to the UE 1204 via the network 1213 and/or a satellite and/or one or more other devices. The assistance information may be transmitted by the assistance server 1202 to one or more intermediate devices such that the UE 1204 may receive the assistance information via a cloud server, an edge server, a gNB/TRP (e.g., via SIB), and/or one or more other devices (e.g., via sidelink and/or P2P communications). The at least one processor 1246, possibly in combination with the at least one memory 1244, possibly in combination with the at least one satellite transceiver 1206 and/or the at least one terrestrial transceiver 1208, may comprise means for transmitting the assistance information to the UE.

Implementations of the method 2200 may include one or more of the following examples. In an example implementation, the communication satellite selection indication comprises an indication of an orbital plane. For example, the table 1900 includes indications of orbital planes as implicit satellite indications. In another example implementation, the decision zone corresponds to an orbital seam. In another example implementation, the decision zone corresponds to a latitude range. In another example implementation, the one or more validity criteria of each of the at least one condition comprises: at least one of a latitude indication of a latitude range of the UE for the respective condition to be applicable or a longitude indication of a longitude range of the UE for the respective condition to be applicable; and a time indication of a time range for the respective condition to be applicable. For example, the validity parameters 1940 may include the latitude range 1912 and may include a longitude range or may be agnostic to longitude range as it relates to polar orbits, and the validity parameters 1940 may include the applicability time 1908 and the validity interval 1910. In another example implementation, each condition of the at least one condition further comprises one or more satellite criteria for a satellite of the plurality of communication satellites to satisfy in order to be considered for use by the UE for communication. For example, each condition may include one or more of the satellite parameters 1950. In a further example implementation, the one or more satellite criteria include: a satellite range with respect to a location of the UE; a satellite direction of travel; an azimuth angle range from the location of the UE; an elevation angle range from the location of the UE; or any combination of two or more thereof. For example, the one or more criteria may include the satellite distance range and the satellite direction of travel, and/or may include the azimuth angle range and the elevation angle range. For example, each of the conditions 1901-1903 includes the satellite parameters 1950.

Also or alternatively, implementations of the method 2200 may include one or more of the following features. In an example implementation, the satellite parameters need not specify any condition, thus allowing all satellites remaining in the input satellite list to be considered as candidate satellites. In another example implementation, the method 2200 includes receiving the orbital information and satellite beam availability information from a constellation operator. For example, at least a respective portion of the orbital information and satellite beam availability information may be received by the assistance server 1202 from a constellation operator. The at least one processor 1246, possibly in combination with the at least one memory 1244, possibly in combination with the at least one satellite transceiver 1206 and/or the at least one terrestrial transceiver 1208, may comprise means for receiving the orbital information and satellite beam availability information from a constellation operator. In another example implementation, the method 2200 includes receiving, at the server, at least a respective portion of the orbital information and satellite beam availability information from each of a plurality of satellite communication devices. For example, the assistance server 1202 may obtain the assistance information from orbital information crowd-sourced by one or more UEs. The at least one processor 1246, possibly in combination with the at least one memory 1244, possibly in combination with the at least one terrestrial transceiver 1208, may comprise means for receiving at least a respective portion of the orbital information from each of a plurality of satellite communication devices. In another example implementation, the communication satellite selection indication includes a prioritized indication of a plurality of orbital planes in which the plurality of communication satellites orbit. For example, the table 1900 includes the set indication 1925 of the condition 1901 indicating a prioritized list of orbital planes.

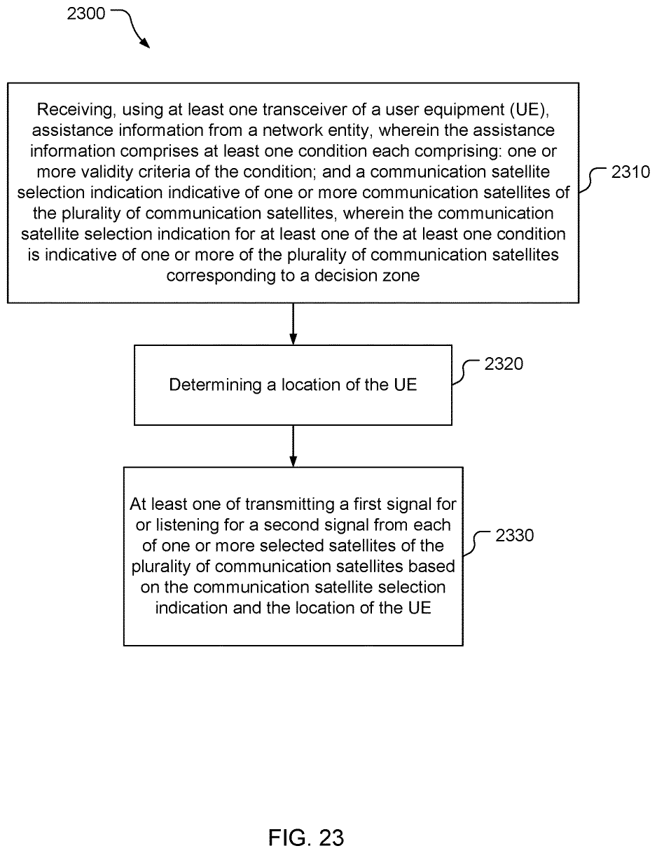

Referring to FIG. 23, with further reference to FIGS. 7-19, a method 2300 for satellite communication includes the stages shown. The method 2300 is, however, an example only and not limiting. The method 2300 may be altered, e.g., by having one or more stages added, removed, rearranged, combined, performed concurrently, and/or having one or more single stages split into multiple stages.

At stage 2310, the method 2300 includes receiving, at a UE, assistance information from a server, wherein the assistance information comprises at least one condition each comprising: one or more validity criteria of the condition; and a communication satellite selection indication indicative of one or more selected communication satellites of a plurality of communication satellites, wherein the communication satellite selection indication for at least one of the at least one condition is indicative of one or more of the plurality of communication satellites corresponding to a decision zone. Stage 2310 may be the same as or similar to stage 1610 discussed above.

At stage 2320, the method 2300 includes determining a location of the UE. Stage 1820 may be the same as or similar to stage 2120 discussed above.

At stage 2330, the method 2300 includes producing directional pointing information to at least one of prompt a user of the UE to direct, or cause the UE to steer, an antenna beam of the UE toward one of one or more selected satellites of the plurality of communication satellites based on the communication satellite selection indication and the location of the UE. For example, at stage 2010, the at least one processor 1246 may determine a preferred satellite orbit or a preferred satellite for the target SV list of satellites based on the orbital seam preference 1924 and the location of the UE 1204. The UE 1204 may attempt to communicate with a highest-priority SV from the target SV list by transmitting a signal to the selected SV (e.g., highest-priority SV) and/or listening for a signal from the selected SV. If that attempt is unsuccessful, then the UE 1204 may attempt to communicate with a next-highest-priority SV, if any, from the target SV list. This may be repeated until communication is successful with an SV or the target SV list is exhausted without successful communication with a satellite by the UE 1204. The at least one processor 1246, possibly in combination with the at least one memory 1244, in combination with the at least one satellite transceiver 1206 may comprise means for at least one of transmitting a first signal for or listening for a second signal from each of one or more selected satellites.

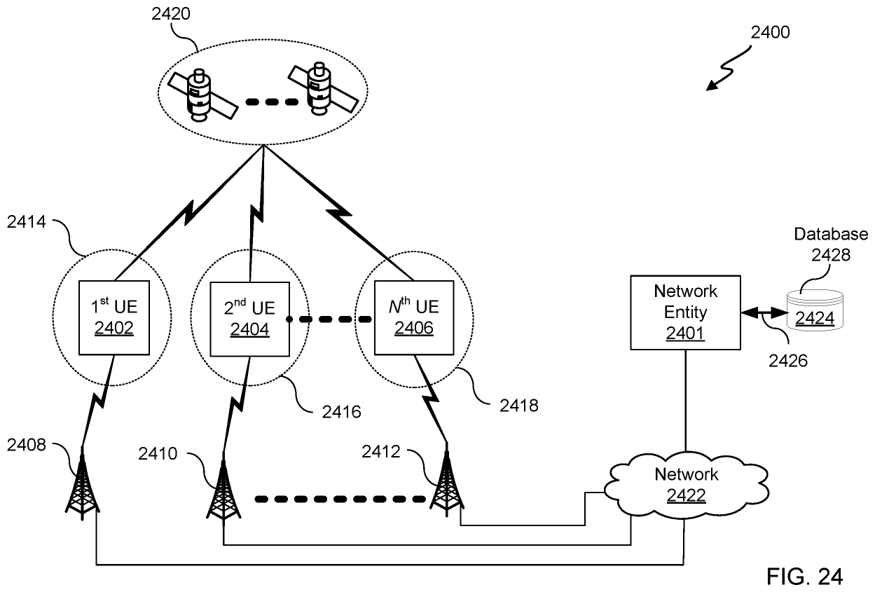

Turning to FIG. 24, a system block diagram is shown of an example of an implementation of a system 2400 for satellite-based communication utilizing crowdsourcing. In this example, the system 2400 may be same as system 1200, described in relation to FIG. 12, utilizing multiple UEs to generate crowdsourcing information that can be sent to a network entity 2401 such as assistance server 1202. Specifically, in this example, a plurality of UEs (i.e., first UE 2402, second UE 2404, through a Nth UE 2406) and shown in signal communication with one or more base stations 2408, 2410, and 2412, respectively. In this example, each UE of the plurality of UEs may be in signal communication with a single base station, each UE may be in signal communication with an individual base station of the one or more base stations, or a combination of both. In this example, each UE is located at a physical location on the Earth such as, for example, first UE 2402, second UE 2404, and Nth UE 2406 may be located at a first location 2414, second location 2416, and Nth location 2418. In this example, the plurality of UEs will attempt to communicate with one or more LEO satellites of the LEO satellite constellation 2420. Each of the one or more base stations 2408, 2410, and 2412 are in signal communication with a network 2422 (i.e., network 1213) that is in signal communication with the network entity 2401. The network entity 2401 may be an assistance server (such as assistance server 1202 that may be an example of the assistance server 702 that may also be an example of the network entity 600) and each UE (i.e., first UE 2402, second UE 2404, through the Nth UE 2406) may be an example of UE 105, UE 500, UE 704, and/or UE 1204. As an example, the network entity 2401 may include a storage device 2424 which may be a part of the network entity 2401 or a separate device or system in signal communication with the network entity 2401. In this example, the LEO satellite constellation 2420 may be LEO satellite constellation 1210 described previously.

As described previously in relation to FIG. 12, the network entity 2401 may be configured to receive orbital information and satellite selection parameters based on beam pattern for communication satellites, and produce assistance information 2426 from the orbital information and satellite selection parameters to help a UE (either the first UE 2402, second UE 2404, or Nth UE 2406) determine an availability of one or more communication satellites with which to attempt to communicate. Different assistance data may be produced and provided to the UE corresponding to different locations of the UE. The network entity 2401 may receive orbital information and satellite selection parameters for the satellites from a constellation operator (e.g., via the network 2422). The orbital information and satellite selection parameters may be sent to the network entity 2401 from a constellation operator that knows, keeps, generates, and updates the orbital information and beam pattern changes for the satellites within the LEO satellite constellation 2420. The network entity 2401 may store the assistance information 2426 in a database 2428 of the storage device 2424.

Alternatively, or in addition to being configured to receive the orbital information from the constellation operator (e.g., via the network 2422), the network entity 2401 may be configured to receive orbital and satellite beam availability related information from the first UE 2402, second UE 2404, or Nth UE 2406 that act as third-party sources that are communicating, or attempting to communicate, with and measuring information of the different LEO satellites of the LEO satellite constellation 2420 at different times and locations (i.e., first location 2414, second location 2416, and Nth location 2418). This orbital and satellite beam availability related information may be obtained by crowdsourcing using the first location 2414, second location 2416, and/or Nth location 2418 that communicate with the network entity 2401. These plurality of UEs may be field trial devices or individual UEs that are crowd-sourced to produce the crowdsourced information. Over time, the network entity 2401 may iteratively produce the assistance information 2426 from this received orbital related crowdsourced information. In both of these examples, the assistance network entity 2401 may include a priori data that will be sent to the UEs for fast acquisition of an LEO satellite of the LEO satellite constellation 2420.

In this example, the crowdsourced information may include information acquired (i.e., measurement information) by the first UE 2402, second UE 2404, and/or Nth UE 2406 regarding whether the first UE 2402, second UE 2404, and/or Nth UE 2406 have been able to communicate with at least one satellite (of the LEO satellite constellation 2420) may be sent from the individual first UE 2402, second UE 2404, or Nth UE 2406 to the network entity 2401. In this example, the first UE 2402, second UE 2404, and/or Nth UE 2406 attempt to communicate with the one or more selected satellites of the plurality of communication satellites based on the communication satellite selection indication and a location of the UE. The network entity 2401 may be configured to receive this crowdsourced information and analyze it to construct or update the conditions, which the network entity 2401 may send to a future UE (i.e., UE 1204). In this example, the assistance information 2426 may include parameters that are pre-determined for satellite selection based on crowdsourced information from either multiple UEs, or the same UE, and performing measurements at different times.

### Implementation Examples

Implementation examples are provided in the following numbered clauses.
Clause 1. A user equipment (UE) comprising: at least one memory; at least one transceiver; at least one positioning device; and at least one processor in signal communication with the at least one memory, the at least one transceiver, and the at least one positioning device, the at least one processor configured to: receive, using the at least one transceiver, assistance information comprising at least one condition each comprising: one or more validity criteria; and a communication satellite selection indication indicative of one or more selected communication satellites of a plurality of communication satellites, wherein the communication satellite selection indication for at least one of the at least one condition is indicative of one or more of the plurality of communication satellites corresponding to a decision zone; determine, from information from the at least one positioning device, a location of the UE; and produce directional pointing information to at least one of prompt a user of the UE to direct, or cause the at least one transceiver to steer, an antenna beam of the at least one transceiver toward the one or more selected satellites of the plurality of communication satellites based on the communication satellite selection indication and the location of the UE.
Clause 2. The UE of clause 1, wherein the at least one processor is further configured to determine a preferred communication satellite, of the plurality of communication satellites, corresponding to the decision zone based on the communication satellite selection indication.
Clause 3. The UE of clause 1 or 2, wherein the decision zone corresponds to an orbital seam.
Clause 4. The UE of clause 1, 2, or 3, wherein the decision zone is a latitude range.
Clause 5. The UE of clause 1, 2, 3, or 4, wherein the communication satellite selection indication is an indication of an orbital plane.
Clause 6. The UE of clause 1, 2, 3, 4, or 5, wherein each condition further comprises one or more satellite criteria for a satellite of the plurality of communication satellites to satisfy to be a candidate satellite that is considered for use by the UE for communication.
Clause 7. The UE of clause 6, wherein the one or more satellite criteria include: a satellite distance range with respect to the location of the UE; a satellite direction of travel; an azimuth angle range from the location of the UE; an elevation angle range from the location of the UE; or any combination of two or more thereof.
Clause 8. The UE of clause 6, or 7, wherein the at least one processor is further configured to determine a position, relative to the UE, of each candidate satellite.
Clause 9. The UE of clause 1, 2, 3, 4, 5, or 6, wherein the at least one processor is configured to produce the directional pointing information to at least one of prompt the user of the UE to direct, or cause the at least one transceiver to steer, the antenna beam of the at least one transceiver toward each of the one or more selected satellites in an order based on a likelihood of availability for each of the one or more selected satellites.
Clause 10. The UE of clause 1, 2, 3, 4, 5, 6, or 9, wherein the one or more validity criteria comprise: at least one of a latitude indication of a latitude range of the UE for the respective condition or a longitude indication of a longitude range of the UE for the respective condition; and a time indication of a time range for the respective condition.
Clause 11. The UE of clause 1, 2, 3, 4, 5, 6, 9, or 10, wherein the at least one processor is further configured to transmit, using the at least one transceiver, crowdsourcing information to a network entity, wherein the crowdsourcing information includes measurement information measured by the UE at a time in response to the UE attempting to communicate with the one of the one or more selected satellites of the plurality of communication satellites based on the communication satellite selection indication and the location of the UE.
Clause 12. The UE of clause 11, wherein the crowdsourcing information includes orbital and satellite beam availability related information for the one or more selected satellites.
Clause 13. A method for providing pointing information associated with a user equipment (UE), the method comprising: receiving, using at least one transceiver of the UE, assistance information from a network entity, wherein the assistance information comprises at least one condition each comprising: one or more validity criteria; and a communication satellite selection indication indicative of one or more selected communication satellites of a plurality of communication satellites, wherein the communication satellite selection indication for at least one of the at least one condition is indicative of one or more of the plurality of communication satellites corresponding to a decision zone; determining a location of the UE; and producing directional pointing information to at least one of prompt a user of the UE to direct, or cause the UE to steer, an antenna beam of the UE toward the one or more selected satellites of the plurality of communication satellites based on the communication satellite selection indication and the location of the UE.
Clause 14. The method of clause 13, further comprising determining a preferred satellite corresponding to the decision zone based on the communication satellite selection indication.
Clause 15. The method of clause 13, or 14, wherein the decision zone corresponds to an orbital seam.
Clause 16. The method of clause 13, 14, or 15, wherein the decision zone is a latitude range.
Clause 17. The method of clause 13, 14, 15, or 16, wherein the communication satellite selection indication is an indication of an orbital plane.
Clause 18. The method of clause 13, 14, 15, 16, or 17, wherein each condition further comprises one or more satellite criteria for a satellite of the plurality of communication satellites to satisfy in order to be a candidate satellite that is considered for use by the UE for communication.
Clause 19. The method of clause 18, wherein the one or more satellite criteria include: a satellite distance range with respect to the location of the UE; a satellite direction of travel; an azimuth angle range from the location of the UE; an elevation angle range from the location of the UE; or any combination of two or more thereof.
Clause 20. The method of clause 18, or 19, further comprising determining a position, relative to the UE, of each candidate satellite.
Clause 21. The method of clause 13, 14, 15, 16, 17, or 18, wherein the producing the directional pointing information to at least one of prompt the user of the UE to direct, or cause the at least one transceiver of the UE to steer, the antenna beam of the at least one transceiver toward each of the one or more selected satellites comprises producing the directional pointing information to at least one of prompt the user of the UE to direct, or cause the at least one transceiver to steer, the antenna beam of the at least one transceiver toward each of the one or more selected satellites in an order based on a likelihood of availability for each of the one or more selected satellites.
Clause 22. The method of clause 13, 14, 15, 16, 17, 18, or 21, wherein the one or more validity criteria comprise: at least one of a latitude indication of a latitude range of the UE for the respective condition or a longitude indication of a longitude range of the UE for the respective condition; and a time indication of a time range for the respective condition.
Clause 23. The method of clause 13, 14, 15, 16, 17, 18, 21, or 22, further including transmitting, using the at least one transceiver, crowdsourcing information to the network entity, wherein the crowdsourcing information includes measurement information measured by the UE at a time when the UE attempted to communicate with the one of the one or more selected satellites of the plurality of communication satellites based on the communication satellite selection indication and the location of the UE.
Clause 24. The method of clause 23, wherein the crowdsourcing information includes orbital and satellite beam availability related information for the one or more selected satellites.
Clause 25. A user equipment (UE) comprising: means for receiving assistance information from a network entity, wherein the assistance information comprises at least one condition each comprising: one or more validity criteria; and a communication satellite selection indication indicative of one or more selected communication satellites of a plurality of communication satellites, wherein the communication satellite selection indication for at least one of the at least one condition is indicative of one or more of the plurality of communication satellites corresponding to a decision zone; means for determining a location of the UE from positioning signals; and means for producing directional pointing information to at least one of prompt a user of the UE to direct, or cause the UE to steer, an antenna beam of the UE toward the one or more selected satellites of the plurality of communication satellites based on the communication satellite selection indication and the location of the UE.
Clause 26. The UE of clause 25, further including means for transmitting crowdsourcing information to the network entity, wherein the crowdsourcing information includes measurement information measured by the UE at a time in response to the UE attempting to communicate with the one of the one or more selected satellites of the plurality of communication satellites based on the communication satellite selection indication and the location of the UE.
Clause 27. The UE of clause 26, wherein the crowdsourcing information includes orbital and satellite beam availability related information for the one or more selected satellites.
Clause 28. A non-transitory, processor-readable storage medium comprising processor-readable instructions to cause at least one processor of a user equipment (UE) to: receive assistance information from a network entity, wherein the assistance information comprises at least one condition each comprising: one or more validity criteria; and a communication satellite selection indication indicative of one or more selected communication satellites of a plurality of communication satellites, wherein the communication satellite selection indication for at least one of the at least one condition is indicative of one or more of the plurality of communication satellites corresponding to a decision zone; determine a location of the UE from positioning signals; and produce directional pointing information to at least one of prompt a user of the UE to direct, or cause the UE to steer, an antenna beam of the UE toward the one or more selected satellites of the plurality of communication satellites based on the communication satellite selection indication and the location of the UE.
Clause 29. The non-transitory, processor-readable storage medium of clause 28, wherein the processor-readable instructions further cause the at least one processor to transmit crowdsourcing information to the network entity, wherein the crowdsourcing information includes measurement information measured by the UE at a time in response to the UE attempting to communicate with the one of the one or more selected satellites of the plurality of communication satellites based on the communication satellite selection indication and the location of the UE.
Clause 30. The non-transitory, processor-readable storage medium of clause 29, wherein the crowdsourcing information includes orbital and satellite beam availability related information for the one of the one or more selected satellites.
Clause 31. A user equipment (UE) comprising: at least one memory; at least one transceiver; at least one positioning device; and at least one processor in signal communication with the at least one memory, the at least one transceiver, and the at least one positioning device, the at least one processor configured to: receive, using the at least one transceiver, assistance information comprising at least one condition each comprising: one or more validity criteria; and a communication satellite selection indication indicative of one or more selected communication satellites of a plurality of communication satellites, wherein the communication satellite selection indication for at least one of the at least one condition is indicative of one or more of the plurality of communication satellites corresponding to a decision zone; determine, from information from the at least one positioning device, a location of the UE; and at least one of transmit a first signal for, or listen for a second signal from, each of one or more selected satellites of the plurality of communication satellites based on the communication satellite selection indication and the location of the UE.
Clause 32. The UE of clause 31, wherein the at least one processor is further configured to transmit, using the at least one transceiver, crowdsourcing information to the network entity, wherein the crowdsourcing information includes measurement information measured by the UE at a time in response to the UE attempting to communicate with the one of the one or more selected satellites of the plurality of communication satellites based on the communication satellite selection indication and the location of the UE.
Clause 33. The UE of clause 32, wherein the crowdsourcing information includes orbital and satellite beam availability related information for the one or more selected satellites.
Clause 34. A method for satellite communication, the method comprising: receiving, using at least one transceiver of a user equipment (UE), assistance information from a network entity, wherein the assistance information comprises at least one condition each comprising: one or more validity criteria of the condition; and a communication satellite selection indication indicative of one or more selected communication satellites of a plurality of communication satellites, wherein the communication satellite selection indication for at least one of the at least one condition is indicative of one or more of the plurality of communication satellites corresponding to a decision zone; determining a location of the UE; and at least one of transmitting a first signal for or listening for a second signal from each of one or more selected satellites of the plurality of communication satellites based on the communication satellite selection indication and the location of the UE.
Clause 35. The method of clause 34, further including transmitting, using the at least one transceiver, crowdsourcing information to the network entity, wherein the crowdsourcing information includes measurement information measured by the UE at a time when the UE attempted to communicate with the one of the one or more selected satellites of the plurality of communication satellites based on the communication satellite selection indication and the location of the UE.
Clause 36. The method of clause 35, wherein the crowdsourcing information includes orbital and satellite beam availability related information for the one of the one or more selected satellites.
Clause 37. A user equipment (UE) comprising: means for receiving assistance information from a network entity, wherein the assistance information comprises at least one condition each comprising: one or more validity criteria of the condition; and a communication satellite selection indication indicative of one or more selected communication satellites of a plurality of communication satellites, wherein the communication satellite selection indication for at least one of the at least one condition is indicative of one or more of the plurality of communication satellites corresponding to a decision zone; means for determining a location of the UE from positioning signals; and means for at least one of transmitting a first signal for or listening for a second signal from each of one or more selected satellites of the plurality of communication satellites based on the communication satellite selection indication and the location of the UE.
Clause 38. The UE of clause 37, further including means for transmitting crowdsourcing information to the network entity, wherein the crowdsourcing information includes measurement information measured by the UE at a time when the UE attempted to communicate with the one of the one or more selected satellites of the plurality of communication satellites based on the communication satellite selection indication and the location of the UE.
Clause 39. The UE of clause 38, wherein the crowdsourcing information includes orbital and satellite beam availability related information for the one of the one or more selected satellites.
Clause 40. A non-transitory, processor-readable storage medium comprising processor-readable instructions to cause at least one processor of a user equipment (UE) to: receive assistance information from the network entity, wherein the assistance information comprises at least one condition each comprising: one or more validity criteria of the condition; and a communication satellite selection indication indicative of one or more selected communication satellites of a plurality of communication satellites, wherein the communication satellite selection indication for at least one of the at least one condition is indicative of one or more of the plurality of communication satellites corresponding to a decision zone; determine a location of the UE from positioning signals; and at least one of transmit a first signal for or listen for a second signal from each of one or more selected satellites of the plurality of communication satellites based on the communication satellite selection indication and the location of the UE.
Clause 41. The non-transitory, processor-readable storage medium of clause 40, wherein the processor-readable instructions further cause the at least one processor to transmit crowdsourcing information to the network entity, wherein the crowdsourcing information includes measurement information measured by the UE at a time when the UE attempted to communicate with the one of the one or more selected satellites of the plurality of communication satellites based on the communication satellite selection indication and the location of the UE.
Clause 42. The non-transitory, processor-readable storage medium of clause 41, wherein the crowdsourcing information includes orbital and satellite beam availability related information for the one of the one or more selected satellites.
Clause 43. A network entity comprising: at least one memory; at least one transceiver; and at least one processor in signal communication with the at least one memory and the at least one transceiver, the at least one processor configured to: obtain assistance information based on orbital information of a plurality of communication satellites, the assistance information comprising at least one condition each comprising: one or more validity criteria; and a communication satellite selection indication indicative of one or more communication satellites of the plurality of communication satellites, wherein the communication satellite selection indication for at least one of the at least one condition is indicative of one or more of the plurality of communication satellites corresponding to a decision zone; and transmit the assistance information to a user equipment (UE) utilizing the at least one transceiver.
Clause 44. The network entity of clause 43, wherein the communication satellite selection indication comprises an indication of an orbital plane.
Clause 45. The network entity of clause 43, or 44, wherein the decision zone corresponds to an orbital seam.
Clause 46. The network entity of clause 43, 44, or 45, wherein the decision zone is a latitude range.
Clause 47. The network entity of clause 43, 44, 45, or 46, wherein the one or more validity criteria of each of the at least one condition comprises: at least one of a latitude indication of a latitude range of the UE for the respective condition to be applicable or longitude indication of a longitude range of the UE for the respective condition to be applicable; and a time indication of a time range for the respective condition to be applicable.
Clause 48. The network entity of clause 43, 44, 45, 46, or 47, wherein each condition of the at least one condition further comprises one or more satellite criteria for a satellite of the plurality of communication satellites to satisfy in order to be considered for use by the UE for communication.
Clause 49. The network entity of clause 48, wherein the one or more satellite criteria include: a satellite distance range with respect to a location of the UE; a satellite direction of travel; an azimuth angle range from the location of the UE; an elevation angle range from the location of the UE; or any combination of two or more thereof.
Clause 50. The network entity of clause 43, 44, 45, 46, 47, or 48, wherein the at least one processor is configured to receive the orbital information and satellite beam availability information from a constellation operator via the at least one transceiver.
Clause 51. The network entity of clause 43, 44, 45, 46, 47, 48, or 50, wherein the at least one processor is configured to receive, via the at least one transceiver, at least a respective portion of the orbital information and satellite beam availability information from each of a plurality of satellite communication devices.
Clause 52. The network entity of clause 43, 44, 45, 46, 47, 48, 50, or 51, wherein the communication satellite selection indication includes a prioritized indication of a plurality of orbital planes in which the plurality of communication satellites orbit.
Clause 53. The network entity of clause 43, 44, 45, 46, 47, 48, 50, 51, or 52, wherein the at least one processor is further configured to receive crowdsourcing information, wherein the crowdsourcing information includes measurement information measured by at least the UE at a time in response to the UE attempting to communicate with the one or more selected satellites of the plurality of communication satellites based on the communication satellite selection indication and a location of the UE.
Clause 54. The network entity of clause 53, wherein the crowdsourcing information includes orbital and satellite beam availability related information for the one or more selected satellites.
Clause 55. The network entity of clause 53, or 54, wherein the assistance information includes at least part of the crowdsourcing information.
Clause 56. A method for providing assistance information, the method comprising: obtaining, at a network entity, assistance information based on orbital information of a plurality of communication satellites, the assistance information comprising at least one condition each comprising: one or more validity criteria of the condition; and a communication satellite selection indication indicative of one or more communication satellites of the plurality of communication satellites, wherein the communication satellite selection indication for at least one of the at least one condition is indicative of one or more of the plurality of communication satellites corresponding to a decision zone; and transmitting, utilizing at least one transceiver, the assistance information from the network entity to a user equipment (UE).
Clause 57. The method of clause 56, wherein the communication satellite selection indication comprises an indication of an orbital plane.
Clause 58. The method of clause 56, or 57, wherein the decision zone corresponds to an orbital seam.
Clause 59. The method of clause 56, 57, or 58, wherein the decision zone is a latitude range.
Clause 60. The method of clause 56, 57, 58, or 59, wherein the one or more validity criteria of each of the at least one condition comprises: at least one of a latitude indication of a latitude range of the UE for the respective condition to be applicable or longitude indication of a longitude range of the UE for the respective condition to be applicable; and a time indication of a time range for the respective condition to be applicable.
Clause 61. The method of clause 56, 57, 58, 59, or 60, wherein each condition of the at least one condition further comprises one or more satellite criteria for a satellite of the plurality of communication satellites to satisfy in order to be considered for use by the UE for communication.
Clause 62. The method of clause 61, wherein the one or more satellite criteria include: a satellite distance range with respect to a location of the UE; a satellite direction of travel; an azimuth angle range from the location of the UE; an elevation angle range from the location of the UE; or any combination of two or more thereof.
Clause 63. The method of clause 56, 57, 58, 59, 60, or 61, further comprising receiving the orbital information and satellite beam availability information at the network entity from a constellation operator.
Clause 64. The method of clause 56, 57, 58, 59, 60, 61, or 63, further comprising receiving, at the network entity, at least a respective portion of the orbital information and satellite beam availability information from each of a plurality of satellite communication devices.
Clause 65. The method of clause 56, 57, 58, 59, 60, 61, 63, or 64, wherein the communication satellite selection indication includes a prioritized indication of a plurality of orbital planes in which the plurality of communication satellites orbit.
Clause 66. The method of clause 56, 57, 58, 59, 60, 61, 63, 64, or 65, further including receiving crowdsourcing information, wherein the crowdsourcing information includes measurement information measured by at least the UE at a time when the UE attempted to communicate with the one of the one or more selected satellites of the plurality of communication satellites based on the communication satellite selection indication and a location of the UE.
Clause 67. The method of clause 66, wherein the crowdsourcing information includes orbital and satellite beam availability related information for the one of the one or more selected satellites.
Clause 68. The method of clause 66, or 67, wherein the assistance information includes at least part of the crowdsourcing information.
Clause 69. A network entity comprising: means for obtaining assistance information based on orbital information of a plurality of communication satellites, the assistance information comprising at least one condition each comprising: one or more validity criteria of the condition; and a communication satellite selection indication indicative of one or more communication satellites of the plurality of communication satellites, wherein the communication satellite selection indication for at least one of the at least one condition is indicative of one or more of the plurality of communication satellites corresponding to a decision zone; and means for transmitting the assistance information from the network entity to a user equipment (UE).
Clause 70. The network entity of clause 69, further including receiving crowdsourcing information, wherein the crowdsourcing information includes measurement information measured by at least the UE at a time when the UE attempted to communicate with the one of the one or more selected satellites of the plurality of communication satellites based on the communication satellite selection indication and a location of the UE.
Clause 71. The network entity of clause 70, wherein the crowdsourcing information includes orbital and satellite beam availability related information for the one of the one or more selected satellites.
Clause 72. The network entity of clause 70, or 71, wherein the assistance information includes at least part of the crowdsourcing information.
Clause 73. A non-transitory, processor-readable storage medium comprising processor-readable instructions to cause at least one processor of a network entity to: obtain assistance information based on orbital information of a plurality of communication satellites, the assistance information comprising at least one condition each comprising: one or more validity criteria of the condition; and a communication satellite selection indication indicative of one or more communication satellites of the plurality of communication satellites, wherein the communication satellite selection indication for at least one of the at least one condition is indicative of one or more of the plurality of communication satellites corresponding to a decision zone; and transmit the assistance information from the network entity to a user equipment.
Clause 74. The non-transitory, processor-readable storage medium of clause 73, wherein the processor-readable instructions further cause the at least one processor to receive crowdsourcing information, wherein the crowdsourcing information includes measurement information measured by at least the UE at a time when the UE attempted to communicate with the one of the one or more selected satellites of the plurality of communication satellites based on the communication satellite selection indication and a location of the UE.
Clause 75. The non-transitory, processor-readable storage medium of clause 74, wherein the crowdsourcing information includes orbital and satellite beam availability related information for the one of the one or more selected satellites.
Clause 76. The non-transitory, processor-readable storage medium of clause 74, or 75, wherein the assistance information includes at least part of the crowdsourcing information.

Other devices, apparatuses, systems, methods, features, and advantages of the invention will be or will become apparent to one with skill in the art upon examination of the following figures and detailed description. It is intended that all such additional devices, apparatuses, systems, methods, features, and advantages be included within this description, be within the scope of the invention, and be protected by the accompanying Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations. For example, one or more functions, or one or more portions thereof, discussed above as occurring in a network entity may be performed outside of the network entity.

As used herein, the singular forms “a,” “an,” and “the” include the plural forms as well, unless the context clearly indicates otherwise. Thus, reference to a device in the singular (e.g., “a device,” “the device”), including in the claims, includes at least one, i.e., one or more, of such devices (e.g., “a processor” includes at least one processor (e.g., one processor, two processors, etc.), “the processor” includes at least one processor, “a memory” includes at least one memory, “the memory” includes at least one memory, etc.). The phrases “at least one” and “one or more” are used interchangeably and such that “at least one” referred-to object and “one or more” referred-to objects include implementations that have one referred-to object and implementations that have multiple referred-to objects. For example, “at least one processor” and “one or more processors” each includes implementations that have one processor and implementations that have multiple processors.

The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices. A wireless communication system (also called a wireless communications system, a wireless communication network, or a wireless communications network) may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or ±0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or ±0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. A user equipment (UE) comprising:
at least one memory;
at least one transceiver;
at least one positioning device; and
at least one processor in signal communication with the at least one memory, the at least one transceiver, and the at least one positioning device, the at least one processor configured to:
receive, using the at least one transceiver, assistance information comprising at least one condition each comprising:
one or more validity criteria; and
a communication satellite selection indication indicative of one or more selected communication satellites of a plurality of communication satellites, wherein the communication satellite selection indication for at least one of the at least one condition is indicative of one or more of the plurality of communication satellites corresponding to a decision zone;
determine, from information from the at least one positioning device, a location of the UE; and
produce directional pointing information to at least one of prompt a user of the UE to direct, or cause the at least one transceiver to steer, an antenna beam of the at least one transceiver toward the one or more selected satellites of the plurality of communication satellites based on the communication satellite selection indication and the location of the UE.

2. The UE of claim 1, wherein the at least one processor is further configured to determine a preferred communication satellite, of the plurality of communication satellites, corresponding to the decision zone based on the communication satellite selection indication.

3. The UE of claim 1, wherein the decision zone corresponds to an orbital seam.

4. The UE of claim 1, wherein the decision zone is a latitude range.

5. The UE of claim 1, wherein the communication satellite selection indication is an indication of an orbital plane.

6. The UE of claim 1, wherein each condition further comprises one or more satellite criteria for a satellite of the plurality of communication satellites to satisfy to be a candidate satellite that is considered for use by the UE for communication.

7. The UE of claim 6, wherein the one or more satellite criteria include:
a satellite distance range with respect to the location of the UE;
a satellite direction of travel;
an azimuth angle range from the location of the UE;
an elevation angle range from the location of the UE; or
any combination of two or more thereof.

8. The UE of claim 6, wherein the at least one processor is further configured to determine a position, relative to the UE, of each candidate satellite.

9. The UE of claim 1, wherein the at least one processor is configured to produce the directional pointing information to at least one of prompt the user of the UE to direct, or cause the at least one transceiver to steer, the antenna beam of the at least one transceiver toward each of the one or more selected satellites in an order based on a likelihood of availability for each of the one or more selected satellites.

10. The UE of claim 1, wherein the one or more validity criteria comprise:
at least one of a latitude indication of a latitude range of the UE for the respective condition or a longitude indication of a longitude range of the UE for the respective condition; and
a time indication of a time range for the respective condition.

11. The UE of claim 1, wherein the at least one processor is further configured to
transmit, using the at least one transceiver, crowdsourcing information to a network entity, wherein the crowdsourcing information includes measurement information measured by the UE at a time in response to the UE attempting to communicate with the one of the one or more selected satellites of the plurality of communication satellites based on the communication satellite selection indication and the location of the UE.

12. The UE of claim 11, wherein the crowdsourcing information includes orbital and satellite beam availability related information for the one or more selected satellites.

13. A method for providing pointing information associated with a user equipment (UE), the method comprising:
receiving, using at least one transceiver of the UE, assistance information from a network entity, wherein the assistance information comprises at least one condition each comprising:
one or more validity criteria; and
a communication satellite selection indication indicative of one or more selected communication satellites of a plurality of communication satellites, wherein the communication satellite selection indication for at least one of the at least one condition is indicative of one or more of the plurality of communication satellites corresponding to a decision zone;
determining a location of the UE; and
producing directional pointing information to at least one of prompt a user of the UE to direct, or cause the UE to steer, an antenna beam of the UE toward the one or more selected satellites of the plurality of communication satellites based on the communication satellite selection indication and the location of the UE.

14. The method of claim 13, further comprising determining a preferred satellite corresponding to the decision zone based on the communication satellite selection indication.

15. The method of claim 13, wherein the decision zone corresponds to an orbital seam.

16. The method of claim 13, wherein the decision zone is a latitude range.

17. The method of claim 13, wherein the communication satellite selection indication is an indication of an orbital plane.

18. The method of claim 13, wherein each condition further comprises one or more satellite criteria for a satellite of the plurality of communication satellites to satisfy in order to be a candidate satellite that is considered for use by the UE for communication.

19. The method of claim 18, wherein the one or more satellite criteria include:
a satellite distance range with respect to the location of the UE;
a satellite direction of travel;
an azimuth angle range from the location of the UE;
an elevation angle range from the location of the UE; or
any combination of two or more thereof.

20. The method of claim 18, further comprising determining a position, relative to the UE, of each candidate satellite.

21. The method of claim 13, wherein the producing the directional pointing information to at least one of prompt the user of the UE to direct, or cause the at least one transceiver of the UE to steer, the antenna beam of the at least one transceiver toward each of the one or more selected satellites comprises producing the directional pointing information to at least one of prompt the user of the UE to direct, or cause the at least one transceiver to steer, the antenna beam of the at least one transceiver toward each of the one or more selected satellites in an order based on a likelihood of availability for each of the one or more selected satellites.

22. The method of claim 13, wherein the one or more validity criteria comprise:
at least one of a latitude indication of a latitude range of the UE for the respective condition or a longitude indication of a longitude range of the UE for the respective condition; and
a time indication of a time range for the respective condition.

23. The method of claim 13, further including
transmitting, using the at least one transceiver, crowdsourcing information to the network entity, wherein the crowdsourcing information includes measurement information measured by the UE at a time when the UE attempted to communicate with the one of the one or more selected satellites of the plurality of communication satellites based on the communication satellite selection indication and the location of the UE.

24. The method of claim 23, wherein the crowdsourcing information includes orbital and satellite beam availability related information for the one or more selected satellites.

25. A user equipment (UE) comprising:
means for receiving assistance information from a network entity, wherein the assistance information comprises at least one condition each comprising:
one or more validity criteria; and
a communication satellite selection indication indicative of one or more selected communication satellites of a plurality of communication satellites, wherein the communication satellite selection indication for at least one of the at least one condition is indicative of one or more of the plurality of communication satellites corresponding to a decision zone;
means for determining a location of the UE from positioning signals; and
means for producing directional pointing information to at least one of prompt a user of the UE to direct, or cause the UE to steer, an antenna beam of the UE toward the one or more selected satellites of the plurality of communication satellites based on the communication satellite selection indication and the location of the UE.

26. The UE of claim 25, further including
means for transmitting crowdsourcing information to the network entity, wherein the crowdsourcing information includes measurement information measured by the UE at a time in response to the UE attempting to communicate with the one of the one or more selected satellites of the plurality of communication satellites based on the communication satellite selection indication and the location of the UE.

27. The UE of claim 26, wherein the crowdsourcing information includes orbital and satellite beam availability related information for the one or more selected satellites.

28. A non-transitory, processor-readable storage medium comprising processor-readable instructions to cause at least one processor of a user equipment (UE) to:
receive assistance information from a network entity, wherein the assistance information comprises at least one condition each comprising:
one or more validity criteria; and
a communication satellite selection indication indicative of one or more selected communication satellites of a plurality of communication satellites, wherein the communication satellite selection indication for at least one of the at least one condition is indicative of one or more of the plurality of communication satellites corresponding to a decision zone;
determine a location of the UE from positioning signals; and
produce directional pointing information to at least one of prompt a user of the UE to direct, or cause the UE to steer, an antenna beam of the UE toward the one or more selected satellites of the plurality of communication satellites based on the communication satellite selection indication and the location of the UE.

29. The non-transitory, processor-readable storage medium of claim 28, wherein the processor-readable instructions further cause the at least one processor to
transmit crowdsourcing information to the network entity, wherein the crowdsourcing information includes measurement information measured by the UE at a time in response to the UE attempting to communicate with the one of the one or more selected satellites of the plurality of communication satellites based on the communication satellite selection indication and the location of the UE.

30. The non-transitory, processor-readable storage medium of claim 29, wherein the crowdsourcing information includes orbital and satellite beam availability related information for the one of the one or more selected satellites.

31. A user equipment (UE) comprising:
at least one memory;
at least one transceiver;
at least one positioning device; and
at least one processor in signal communication with the at least one memory, the at least one transceiver, and the at least one positioning device, the at least one processor configured to:
receive, using the at least one transceiver, assistance information comprising at least one condition each comprising:
one or more validity criteria; and
a communication satellite selection indication indicative of one or more selected communication satellites of a plurality of communication satellites, wherein the communication satellite selection indication for at least one of the at least one condition is indicative of one or more of the plurality of communication satellites corresponding to a decision zone;
determine, from information from the at least one positioning device, a location of the UE; and
at least one of transmit a first signal for, or listen for a second signal from, each of one or more selected satellites of the plurality of communication satellites based on the communication satellite selection indication and the location of the UE.

32. The UE of claim 31, wherein the at least one processor is further configured to
transmit, using the at least one transceiver, crowdsourcing information to a network entity, wherein the crowdsourcing information includes measurement information measured by the UE at a time in response to the UE attempting to communicate with the one of the one or more selected satellites of the plurality of communication satellites based on the communication satellite selection indication and the location of the UE.

33. The UE of claim 32, wherein the crowdsourcing information includes orbital and satellite beam availability related information for the one or more selected satellites.

34. A method for satellite communication, the method comprising:
receiving, using at least one transceiver of a user equipment (UE), assistance information from a network entity, wherein the assistance information comprises at least one condition each comprising:
one or more validity criteria of the condition; and
a communication satellite selection indication indicative of one or more selected communication satellites of a plurality of communication satellites, wherein the communication satellite selection indication for at least one of the at least one condition is indicative of one or more of the plurality of communication satellites corresponding to a decision zone;
determining a location of the UE; and
at least one of transmitting a first signal for or listening for a second signal from each of one or more selected satellites of the plurality of communication satellites based on the communication satellite selection indication and the location of the UE.

35. The method of claim 34, further including
transmitting, using the at least one transceiver, crowdsourcing information to the network entity, wherein the crowdsourcing information includes measurement information measured by the UE at a time when the UE attempted to communicate with the one of the one or more selected satellites of the plurality of communication satellites based on the communication satellite selection indication and the location of the UE.

36. The method of claim 35, wherein the crowdsourcing information includes orbital and satellite beam availability related information for the one of the one or more selected satellites.

37. A user equipment (UE) comprising:
means for receiving assistance information from a network entity, wherein the assistance information comprises at least one condition each comprising:
one or more validity criteria of the condition; and
a communication satellite selection indication indicative of one or more selected communication satellites of a plurality of communication satellites, wherein the communication satellite selection indication for at least one of the at least one condition is indicative of one or more of the plurality of communication satellites corresponding to a decision zone;
means for determining a location of the UE from positioning signals; and
means for at least one of transmitting a first signal for or listening for a second signal from each of one or more selected satellites of the plurality of communication satellites based on the communication satellite selection indication and the location of the UE.

38. The UE of claim 37, further including
means for transmitting crowdsourcing information to a network entity, wherein the crowdsourcing information includes measurement information measured by the UE at a time when the UE attempted to communicate with the one of the one or more selected satellites of the plurality of communication satellites based on the communication satellite selection indication and the location of the UE.

39. The UE of claim 38, wherein the crowdsourcing information includes orbital and satellite beam availability related information for the one of the one or more selected satellites.

40. A non-transitory, processor-readable storage medium comprising processor-readable instructions to cause at least one processor of a user equipment (UE) to:
receive assistance information from a network entity, wherein the assistance information comprises at least one condition each comprising:
one or more validity criteria of the condition; and
a communication satellite selection indication indicative of one or more selected communication satellites of a plurality of communication satellites, wherein the communication satellite selection indication for at least one of the at least one condition is indicative of one or more of the plurality of communication satellites corresponding to a decision zone;
determine a location of the UE from positioning signals; and
at least one of transmit a first signal for or listen for a second signal from each of one or more selected satellites of the plurality of communication satellites based on the communication satellite selection indication and the location of the UE.

41. The non-transitory, processor-readable storage medium of claim 40, wherein the processor-readable instructions further cause the at least one processor to
transmit crowdsourcing information to the network entity, wherein the crowdsourcing information includes measurement information measured by the UE at a time when the UE attempted to communicate with the one of the one or more selected satellites of the plurality of communication satellites based on the communication satellite selection indication and the location of the UE.

42. The non-transitory, processor-readable storage medium of claim 41, wherein the crowdsourcing information includes orbital and satellite beam availability related information for the one of the one or more selected satellites.

43. A network entity comprising:
at least one memory;
at least one transceiver; and
at least one processor in signal communication with the at least one memory and the at least one transceiver, the at least one processor configured to:
obtain assistance information based on orbital information of a plurality of communication satellites, the assistance information comprising at least one condition each comprising:
one or more validity criteria; and
a communication satellite selection indication indicative of one or more selected communication satellites of the plurality of communication satellites, wherein the communication satellite selection indication for at least one of the at least one condition is indicative of one or more of the plurality of communication satellites corresponding to a decision zone; and
transmit the assistance information to a user equipment (UE) utilizing the at least one transceiver.

44. The network entity of claim 43, wherein the communication satellite selection indication comprises an indication of an orbital plane.

45. The network entity of claim 43, wherein the decision zone corresponds to an orbital seam.

46. The network entity of claim 43, wherein the decision zone is a latitude range.

47. The network entity of claim 43, wherein the one or more validity criteria of each of the at least one condition comprises:
at least one of a latitude indication of a latitude range of the UE for the respective condition to be applicable or longitude indication of a longitude range of the UE for the respective condition to be applicable; and
a time indication of a time range for the respective condition to be applicable.

48. The network entity of claim 43, wherein each condition of the at least one condition further comprises one or more satellite criteria for a satellite of the plurality of communication satellites to satisfy in order to be considered for use by the UE for communication.

49. The network entity of claim 48, wherein the one or more satellite criteria include:
a satellite distance range with respect to a location of the UE;
a satellite direction of travel;
an azimuth angle range from the location of the UE;
an elevation angle range from the location of the UE; or
any combination of two or more thereof.

50. The network entity of claim 43, wherein the at least one processor is configured to receive the orbital information and satellite beam availability information from a constellation operator via the at least one transceiver.

51. The network entity of claim 43, wherein the at least one processor is configured to receive, via the at least one transceiver, at least a respective portion of the orbital information and satellite beam availability information from each of a plurality of satellite communication devices.

52. The network entity of claim 43, wherein the communication satellite selection indication includes a prioritized indication of a plurality of orbital planes in which the plurality of communication satellites orbit.

53. The network entity of claim 43, wherein the at least one processor is further configured to
receive crowdsourcing information, wherein the crowdsourcing information includes measurement information measured by at least the UE at a time in response to the UE attempting to communicate with the one or more selected satellites of the plurality of communication satellites based on the communication satellite selection indication and a location of the UE.

54. The network entity of claim 53, wherein the crowdsourcing information includes orbital and satellite beam availability related information for the one or more selected satellites.

55. The network entity of claim 53, wherein the assistance information includes at least part of the crowdsourcing information.

56. A method for providing assistance information, the method comprising:
obtaining, at a network entity, assistance information based on orbital information of a plurality of communication satellites, the assistance information comprising at least one condition each comprising:
one or more validity criteria of the condition; and
a communication satellite selection indication indicative of one or more selected communication satellites of the plurality of communication satellites, wherein the communication satellite selection indication for at least one of the at least one condition is indicative of one or more of the plurality of communication satellites corresponding to a decision zone; and
transmitting, utilizing at least one transceiver, the assistance information from the network entity to a user equipment (UE).

57. The method of claim 56, wherein the communication satellite selection indication comprises an indication of an orbital plane.

58. The method of claim 56, wherein the decision zone corresponds to an orbital seam.

59. The method of claim 56, wherein the decision zone is a latitude range.

60. The method of claim 56, wherein the one or more validity criteria of each of the at least one condition comprises:
at least one of a latitude indication of a latitude range of the UE for the respective condition to be applicable or longitude indication of a longitude range of the UE for the respective condition to be applicable; and
a time indication of a time range for the respective condition to be applicable.

61. The method of claim 56, wherein each condition of the at least one condition further comprises one or more satellite criteria for a satellite of the plurality of communication satellites to satisfy in order to be considered for use by the UE for communication.

62. The method of claim 61, wherein the one or more satellite criteria include:
a satellite distance range with respect to a location of the UE;
a satellite direction of travel;
an azimuth angle range from the location of the UE;
an elevation angle range from the location of the UE; or
any combination of two or more thereof.

63. The method of claim 56, further comprising receiving the orbital information and satellite beam availability information at the network entity from a constellation operator.

64. The method of claim 56, further comprising receiving, at the network entity, at least a respective portion of the orbital information and satellite beam availability information from each of a plurality of satellite communication devices.

65. The method of claim 56, wherein the communication satellite selection indication includes a prioritized indication of a plurality of orbital planes in which the plurality of communication satellites orbit.

66. The method of claim 56, further including
receiving crowdsourcing information, wherein the crowdsourcing information includes measurement information measured by at least the UE at a time when the UE attempted to communicate with the one of the one or more selected satellites of the plurality of communication satellites based on the communication satellite selection indication and a location of the UE.

67. The method of claim 66, wherein the crowdsourcing information includes orbital and satellite beam availability related information for the one of the one or more selected satellites.

68. The method of claim 66, wherein the assistance information includes at least part of the crowdsourcing information.

69. A network entity comprising:
means for obtaining assistance information based on orbital information of a plurality of communication satellites, the assistance information comprising at least one condition each comprising:
one or more validity criteria of the condition; and
a communication satellite selection indication indicative of one or more selected communication satellites of the plurality of communication satellites, wherein the communication satellite selection indication for at least one of the at least one condition is indicative of one or more of the plurality of communication satellites corresponding to a decision zone; and
means for transmitting the assistance information from the network entity to a user equipment (UE).

70. The network entity of claim 69, further including receiving crowdsourcing information, wherein the crowdsourcing information includes measurement information measured by at least the UE at a time when the UE attempted to communicate with the one of the one or more selected satellites of the plurality of communication satellites based on the communication satellite selection indication and a location of the UE.

71. The network entity of claim 70, wherein the crowdsourcing information includes orbital and satellite beam availability related information for the one of the one or more selected satellites.

72. The network entity of claim 70, wherein the assistance information includes at least part of the crowdsourcing information.

73. A non-transitory, processor-readable storage medium comprising processor-readable instructions to cause at least one processor of a network entity to:
obtain assistance information based on orbital information of a plurality of communication satellites, the assistance information comprising at least one condition each comprising:
one or more validity criteria of the condition; and
a communication satellite selection indication indicative of one or more selected communication satellites of the plurality of communication satellites, wherein the communication satellite selection indication for at least one of the at least one condition is indicative of one or more of the plurality of communication satellites corresponding to a decision zone; and
transmit the assistance information from the network entity to a user equipment.

74. The non-transitory, processor-readable storage medium of claim 73, wherein the processor-readable instructions further cause the at least one processor to
receive crowdsourcing information, wherein the crowdsourcing information includes measurement information measured by at least the UE at a time when the UE attempted to communicate with the one of the one or more selected satellites of the plurality of communication satellites based on the communication satellite selection indication and a location of the UE.

75. The non-transitory, processor-readable storage medium of claim 74, wherein the crowdsourcing information includes orbital and satellite beam availability related information for the one of the one or more selected satellites.

76. The non-transitory, processor-readable storage medium of claim 74, wherein the assistance information includes at least part of the crowdsourcing information.
